(19) United States
(12) Patent Application Publication
(10) Pub. No.: US 2026/0334447 A1
(43) Pub. Date: Oct. 29, 2026

(54) FISHING TACKLE AND FISHING ASSISTANCE SYSTEM

(71) Applicant: Shimano Inc., Osaka (JP)

(72) Inventors: Hirotaka HONDA, Osaka (JP); Akira NIITSUMA, Osaka (JP)

(21) Appl. No.: 19/646,297

(22) Filed: Apr. 13, 2026

(30) Foreign Application Priority Data
Apr. 24, 2025 (JP) 2025-072701

(51) Int. Cl. A01K 97/12; A01K 89/01; A01K 91/06

(52) U.S. Cl. CPC A01K 97/125; A01K 89/0111; A01K 91/06

(57) ABSTRACT

A fishing tackle including a fishing rod or a fishing reel, the fishing tackle includes a detection unit and a calculation unit. The detection unit is provided on the fishing tackle and outputs a detection value corresponding to an operation of the fishing tackle. The calculation unit calculates and outputs location information indicating a location of a fishing rig attached to a fishing line of the fishing tackle on a basis of the detection value.

### CROSS-REFERENCE TO RELATED APPLICATIONS

This application claims priority to Japanese Patent Application No. 2025-072701, filed on Apr. 24, 2025.The entire disclosure of Japanese Patent Application No. 2025-072701 is hereby incorporated by reference.

### BACKGROUND

### Technical Field

The present disclosure generally relates to a fishing tackle including a fishing rod and/or a fishing reel, and a system for assisting fishing by providing, to an angler, information relating to fishing through the fishing tackle.

### BACKGROUND INFORMATION

For example, in lure fishing, an angler uses a fishing rod and a fishing reel to cast a rig including a lure to a desired point, and then retrieves the rig including the lure. At this time, the angler raises and lowers the fishing rod and operates the handle of the fishing reel to adjust the winding of the fishing line and generate action in the lure.

Japanese Patent No. 7112306 discloses a conventional structure of a spinning reel, and this spinning reel is provided with an acceleration sensor and a rotation sensor. The detection values of the acceleration sensor indicate the three-dimensional movement of the spinning reel attached to the fishing rod. The detection value of the rotation sensor indicates the rotational speed and the number of rotations of the spinning reel handle. As a result of these two detection values being recorded, the angler is able to objectively ascertain their own fishing, which can be used to improve their skills in actual fishing.

### SUMMARY

The spinning reel disclosed in Japanese Patent No. 7112306 outputs information indicating the behavior of the spinning reel, but the angler can ascertain their own fishing only retrospectively. It has been determined that while reel disclosed in Japanese Patent No. 7112306 can contribute to improving actual fishing skills in the future, it does not translate to catch results in real time.

The present disclosure was made in light of such background, and an object thereof is to provide a fishing tackle and a fishing assistance system that allow the angler to recognize the behavior of the fishing rig, such as a lure and rigs, in real time, thereby contributing to improved catch results.

A fishing tackle relating to a first aspect of the present disclosure includes a fishing rod and/or a fishing reel. The fishing tackle comprises a detection unit that is provided on the fishing tackle and outputs a detection value corresponding to an operation of the fishing tackle, and a calculation unit that calculates and outputs location information indicating the location of the fishing rig attached to a fishing line of the fishing tackle on the basis of the detection value.

According to this configuration, location information indicating the location of the fishing rig is calculated and output on the basis of the detection value corresponding to the operation of the fishing tackle. The location information that is output indicates the behavior of the fishing rig. The angler is able to fish while confirming the behavior of the fishing rig. As a result, the angler's catch results can improve.

A fishing tackle of a second aspect according to the first aspect of the present disclosure comprises the fishing reel having a handle and a spool around which a fishing line is wound. The detection unit includes a rotation sensor that detects a detection value corresponding to the rotation of the handle, and an acceleration sensor with three or more axes.

According to this configuration, the calculation unit is able to detect the raising and lowering of the fishing rod by the angler on the basis of the detection values of the acceleration sensor with three or more axes, and is able to detect handle operations by the angler on the basis of the detection value of the rotation sensor. The calculation unit calculates the displacement of the fishing rig on the basis of the handle operations and the raising and lowering of the fishing rod that have been detected.

In a fishing tackle of a third aspect according to the first or second aspect of the present disclosure, the detection unit includes a positional sensor that outputs orientation information indicating an orientation. The location information is coordinate information in a coordinate system having the fishing tackle as the origin and reference axes corresponding to the cardinal directions.

According to this configuration, the calculation unit is able to calculate the location of the fishing rig as coordinates in a coordinate system that uses the angler holding the fishing tackle as a reference point and the cardinal directions (north, south, east, west) as reference axes.

The fishing tackle of a fourth aspect according to any one of the first to the third aspects of the present disclosure comprises a display unit that receives input of the location information and displays the location of the fishing rig indicated by the location information.

According to this configuration, the location of the fishing rig is displayed on the display unit. The angler is able to fish while checking, on the display unit, the location and movement of the fishing rig in water.

The fishing tackle of a fifth aspect according to any one of the first to the fourth aspects of the present disclosure comprises a communication unit that transmits the detection value or the location information.

According to this configuration, the communication unit transmits a detection value detected by the detection unit or location information indicating the location of the fishing rig. Accordingly, the angler can check an image indicating the location of the fishing rig without providing a display unit on the fishing tackle.

The fishing tackle of a sixth aspect according to any one of the first to the third aspects of the present disclosure comprises a display unit that receives input of the location information and fish finder image data representing a fish finder image, and displays a specific object indicating the fishing rig superimposed on the fish finder image.

According to this configuration, the location information of the fishing rig calculated by the calculation unit is input to the display unit that displays the fish finder image. The display unit displays the specific object indicating the fishing rig superimposed on the fish finder image. The angler is able to fish while checking on the display unit, the location of the fishing rig and the location of the school of fish in water.

The fishing tackle of a seventh aspect according to any one of the first to the third aspects of the present disclosure comprises a communication unit that can communicate with a user terminal and that transmits the detection value. The calculation unit includes an application program that is installed on the user terminal and is executed by a computer of the user terminal. The application program executes a display process that inputs and displays, on a display unit of the user terminal, the location of the fishing rig indicated by the location information.

According to this configuration, the location of the fishing rig, which changes over time, is displayed on a display unit of the user terminal that is carried by the angler. The angler is able to fish while checking the behavior of the fishing rig on the display unit.

A fishing assistance system according to an eighth aspect of the present disclosure comprises: a fishing tackle including a fishing rod and/or a fishing reel, a detection unit that outputs a detection value corresponding to an operation of the fishing rod and/or of the fishing reel, and a communication unit that transmits the detected value; an application program installed on a user terminal that includes a display unit, a first communication unit, and a computer; and a management server having a second communication unit and a server controller. The application program causes the computer to execute a process for receiving the detection value transmitted by the communication unit via the first communication unit, and a process for transmitting a data request including the received detection value to the management server via the first communication unit and the Internet. The server controller executes a process for receiving the detection value via the second communication unit, a location information calculation process for calculating location information indicating the location of a fishing rig attached to the fishing tackle on the basis of the received detection value, and an image data response process for responding, to the user terminal via the second communication unit and the Internet, a data response that includes image data representing an assistance image obtained by disposing a specific object representing the fishing rig at a location indicated by the location information, as a response to the data request. The application program causes the computer to execute a process for receiving the data response including the image data via the second communication unit, and a display process for displaying, on the display unit, the assistance image indicated by the received image data.

According to this configuration, the application program causes the display unit of the user terminal to display an assistance image having a specific object indicating the fishing rig. The angler is able to fish while checking the behavior of the fishing rig in water in the assistance image displayed on the display unit. As a result, the angler's catch results improve.

A fishing assistance system according to a ninth aspect of the present disclosure comprises a fishing tackle including a fishing rod and/or a fishing reel, a detection unit that outputs a detection value corresponding to an operation of the fishing rod and/or of the fishing reel, and a communication unit that transmits the detected value; and an application program installed on a user terminal that includes a display unit, a reception unit, and a computer. The application program causes the computer to execute a process for receiving the detection value transmitted by the communication unit via the reception unit, a location information calculation process for calculating location information indicating the location of a fishing rig attached to the fishing tackle on the basis of the received detection value, and a display process for displaying, on the display unit, an assistance image obtained by disposing a specific object representing the fishing rig at a location indicated by the location information.

According to this configuration, since the application program calculates the location of the fishing rig, the management server cannot be necessary.

The fishing tackle and the fishing assistance system according to the present disclosure allows the angler to recognize the behavior of the fishing rig, such as a lure and rigs, in real time, thereby improving the angler's catch results.

### BRIEF DESCRIPTION OF THE DRAWINGS

FIG. 1 is a functional block diagram of a fishing tackle 10 according to a first embodiment.

FIG. 2 is a perspective view of a fishing reel 11.

FIG. 3 is a schematic configuration diagram of a sensor group 40.

FIG. 4 is a flowchart of a detection display process in the first embodiment.

FIG. 5 is a diagram showing an assistance image displayed on a display 35.

FIG. 6 is a functional block diagram of a fishing tackle 60 according to a second embodiment.

FIG. 7 is a perspective view of a fishing reel 61, which is a spinning reel.

FIG. 8 is a flowchart of a detection display process in the second embodiment.

FIG. 9 is a functional block diagram of a fishing tackle 80 according to a third embodiment.

FIG. 10 is a side view of a fishing rod 81.

FIG. 11 is a functional block diagram of a fishing tackle 100 according to a fourth embodiment.

FIG. 12 is a flowchart of a process executed by a detection unit 102, etc., in the fourth embodiment.

FIG. 13 is a diagram showing an assistance image displayed on a display 112 of a monitor device 110.

FIG. 14 is a functional block diagram of a fishing assistance system 130 according to a fifth embodiment.

FIG. 15 is a flowchart of a process executed by a detection unit 102, etc., in the fifth embodiment.

FIG. 16 is a functional block diagram of a fishing assistance system 150 according to a sixth embodiment.

FIG. 17 is a flowchart of a process executed by a detection unit 102 and a user terminal 131 in the sixth embodiment.

### DERAILED DESCRIPTION

Preferred embodiments of the present disclosure will be described below, with reference to the drawings, as appropriate. It should be noted that the present embodiment is merely one aspect of a fishing tackle and a fishing assistance system according to the present disclosure, and it goes without saying that the embodiment can be modified without departing from the gist of the present disclosure.

### FIRST EMBODIMENT

### 1. Overview and features

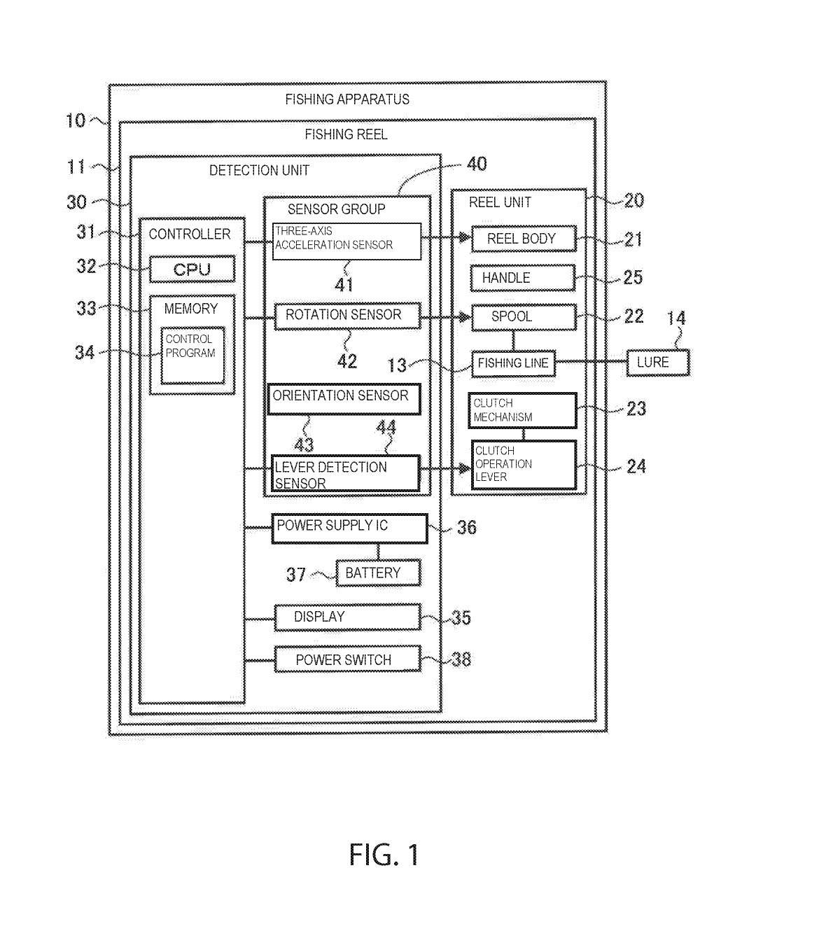

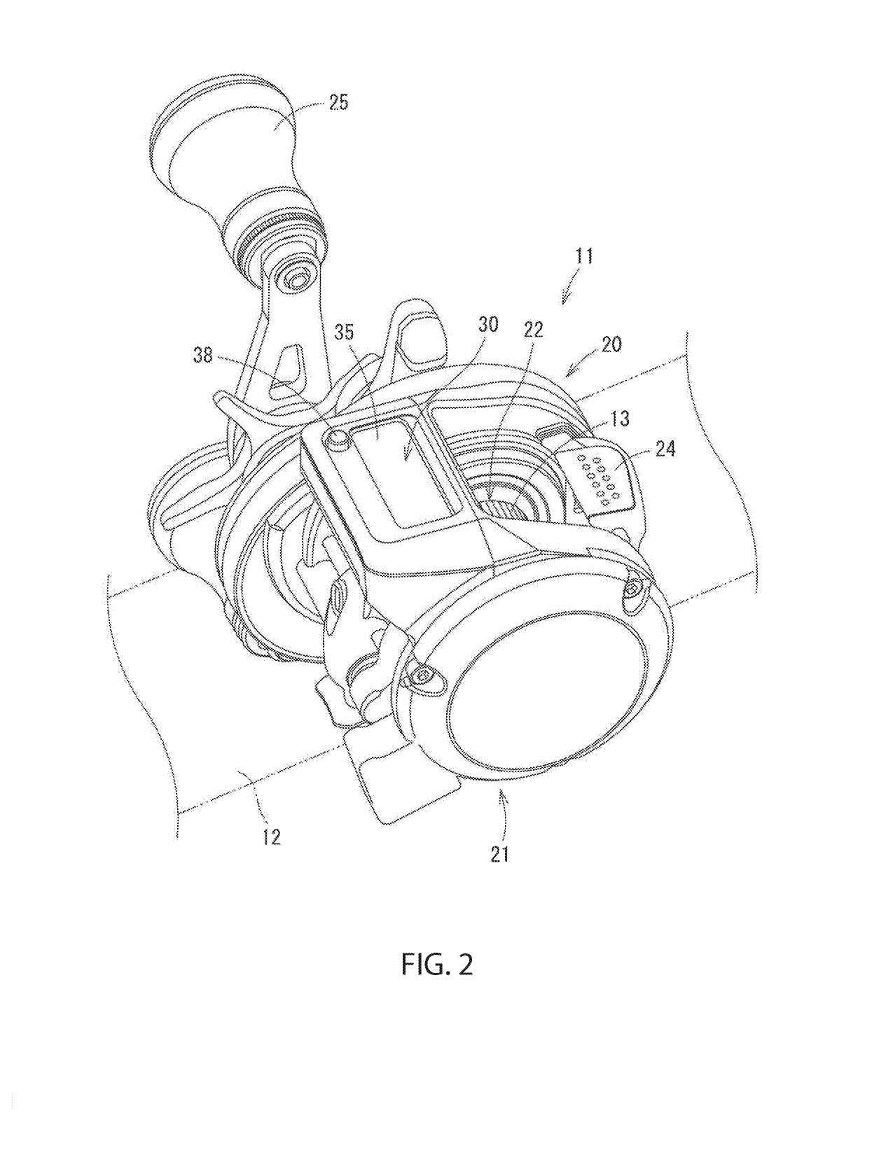

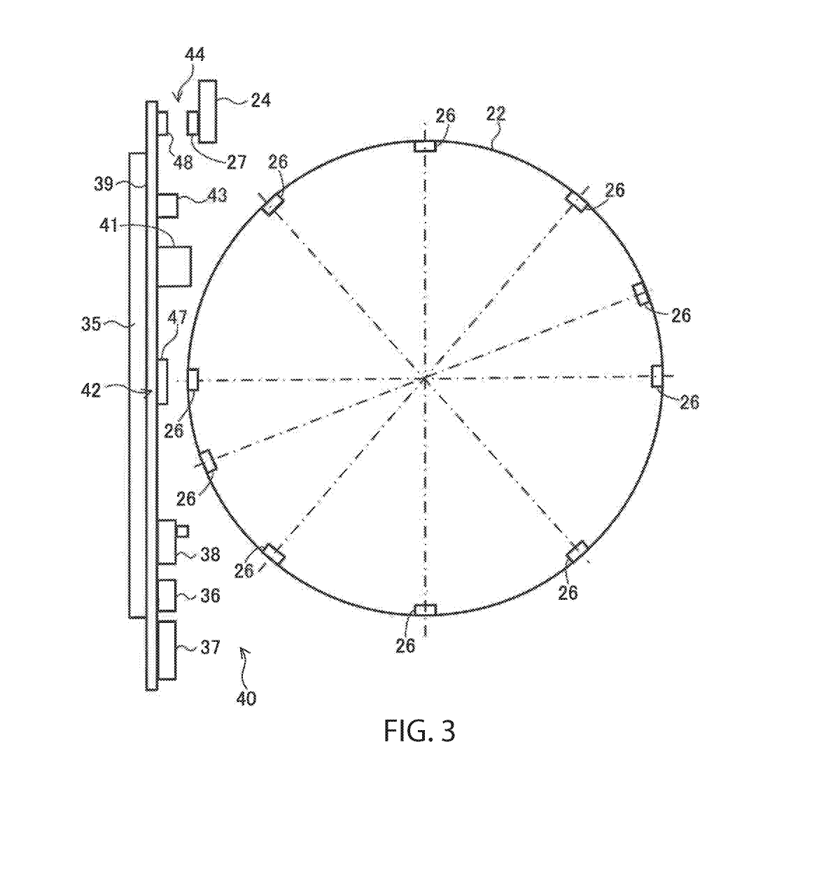

FIG. 1 is a functional block diagram of a fishing tackle 10 according to a first embodiment. FIG. 2 is a perspective view of a fishing reel 11. FIG. 3 is a schematic configuration diagram of a sensor group 40.

The fishing tackle 10 is used for lure fishing in which a lure 14 is cast and retrieved. The lure 14 is one example of "fishing rig" disclosed in the present specification.

A characteristic feature of the fishing tackle 10 according to the present embodiment is that the fishing tackle 10 comprises a detection unit 30. The detection unit 30 detects the behavior of the fishing tackle 10 during casting and retrieving, estimates the behavior of the lure 14 from the detected behavior of the fishing tackle 10, and displays the estimated behavior of the lure 14 on the display 35. That is, the point of having a function to cause the angler to recognize the behavior of the lure 14 in water is the characteristic feature of the fishing tackle 10 according to the present embodiment.

### 2. Configuration of fishing tackle 10

In the present embodiment, an example is described in which the detection unit 30 is provided only on the fishing reel 11 and not on a fishing rod 12 (refer to FIG. 2). The fishing rod 12 is an existing fishing rod, and the length and type are not particularly limited.

The fishing reel 11 comprises a reel 20 and the detection unit (detector) 30.

The reel 20 is an existing fishing reel. That is, the fishing reel 11 of the present embodiment is the reel 20, which is an existing fishing reel, to which the detection unit 30 is attached. However, the specifications of the reel 20 can be modified from an existing fishing reel in order to attach the detection unit 30.

The reel 20 is a dual-bearing reel in which both sides of the rotational axis of a spool 22 are supported by a reel body 21. The dual-bearing reel is a so-called bait reel. The reel 20 has a configuration similar to that of an existing dual-bearing reel, comprising the reel body 21, the spool 22, a clutch mechanism 23, a clutch operation lever 24, a handle 25, and the like.

The reel body 21 supports the spool 22 and the handle 25 so as to be rotatable. The clutch mechanism 23 transmits the rotational motion of the handle 25 to the spool 22. The clutch operation lever 24 switches the engagement and disengagement between the handle 25 and the spool 22 by the clutch lever 23. The position of the clutch operation lever 24 for engaging the handle 25 with the spool 22 is referred to as the "engagement position," and the position of the clutch operation lever 24 for disengaging the handle 25 from the spool 22 is referred to as the "disengagement position." After casting with the clutch operation lever 24 in the disengagement position, the angler puts the clutch operation lever 24 in the engagement position and rotates the handle 25 to carry out retrieval.

The detection unit 30 comprises a controller 31, the display 35, a power supply IC 36, a battery 37, a power switch 38, and the sensor group 40.

The controller 31 can be an electronic controller, which includes memory 33 and a CPU 32, which is a central processing unit. The CPU 32 and the memory 33 are, for example, microcontrollers. The controller 31 is realized by an IC mounted on a printed circuit board 39 (refer to FIG. 3). The printed circuit board 39 is fixed to the reel body 21. The controller 31 is one example of the "calculation unit" described in the present disclosure.

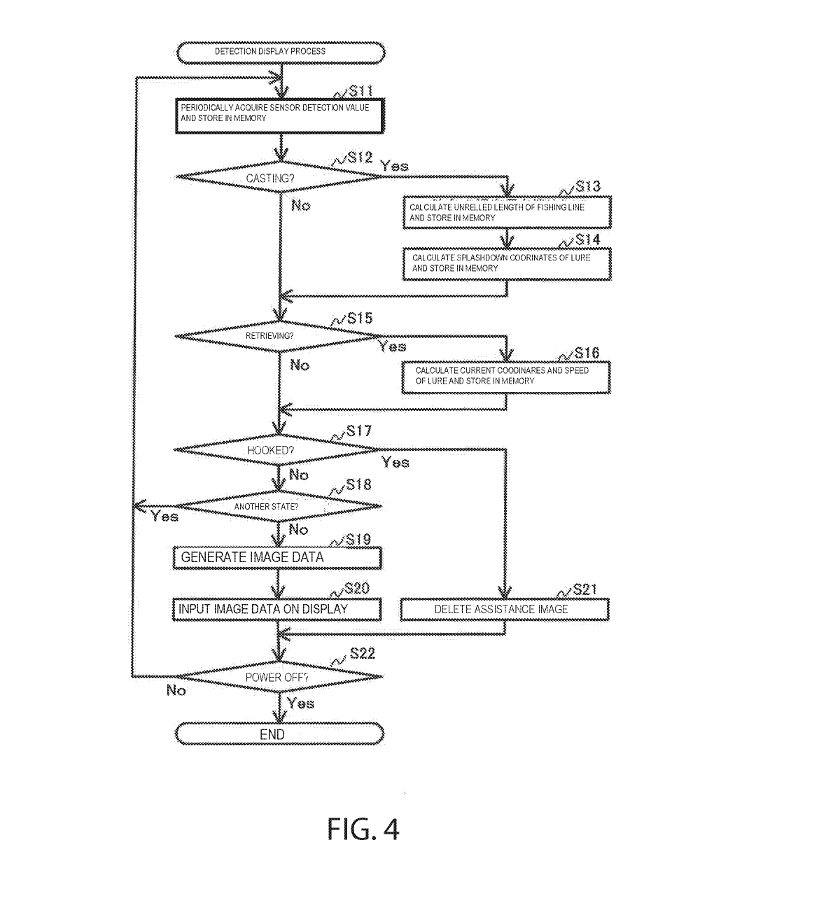

The memory 33 stores a control program 34. The control program 34 is executed by a CPU 32. The control program 34 executes a detection display process (refer to FIG. 4), described further below.

The battery 37 is a primary or a secondary battery. The power supply IC 36 is, for example, a DC/DC converter. The battery 37 is mounted in a socket provided on the printed circuit board 39. The power supply IC 36 is mounted on the printed circuit board 39. The battery 37 is connected to the input side of the power supply IC 36 by a pattern on the printed circuit board 39. The power supply IC 36 converts DC voltage output by the battery 37 to a prescribed, stable DC voltage and outputs the converted voltage. The conversion of the DC voltage includes step-up as well as step-down conversion. The DC voltage output by the power supply IC 36 is supplied to the controller 31, the display 35, and the sensor group 40 via the pattern on the printed circuit board 39.

As shown in FIG. 2, the display 35 is mounted on the printed circuit board 39. The display 35 is electrically connected to the controller 31 and the power supply IC 36. As shown in FIG. 2, the display surface of the display 35 is exposed to the outside, and displays an image indicated by the image data input from the controller 31. The display 35 is, for example, an LCD (Liquid Crystal Display). However, the display 35 can be any type of display device. The display 35 corresponds is one example of the "display unit" described in the present disclosure. The arranged position and orientation of the printed circuit board 39 with respect to the spool 22 shown in FIG. 2 are merely examples and are not limited to the same position and orientation. In addition, the arranged position and orientation of the display 35 shown in FIG. 2 are also merely examples and are not limited to the same position and orientation.

The power switch 38 includes an operating part that is pressed by the angler and that is mounted on the printed circuit board 39. The power switch 38 is, for example, a microswitch or a tactile switch.

The sensor group 40 includes an acceleration sensor 41, a rotation sensor 42, a positional sensor 43, and a lever detection sensor 44. The sensor group 40 is one example of the "detection unit" described in the present disclosure.

As shown in FIG. 3, the acceleration sensor 41 is mounted on the printed circuit board 39. The acceleration sensor 41 has three acceleration sensors configured to determine the acceleration in three different axis or directions. The three directions detected by each of the three acceleration sensors are orthogonal to each other. For example, the three acceleration sensors detect acceleration in three directions: the direction perpendicular to the drawing of FIG. 3, the left-right direction of FIG. 3, and the up-down direction of FIG. 3.

The acceleration sensor 41 detects the acceleration generated in the fishing reel 11 due to the casting and retrieving of the angler. That is, the values detected by the of the acceleration sensor 41 indicate the strength with which, and the directions in which, the angler carried out casting and retrieving and generated acceleration in the fishing reel 11. In addition, the values detected by the acceleration sensor 41 also indicate the attitude of the fishing reel 11.

The positional sensor 43 is mounted on the printed circuit board 39. The positional sensor 43 is a geomagnetic sensor that detects geomagnetism, for example. The positional sensor 43 outputs, as a detection value, a position corresponding to the orientation of the fishing reel 11, and substantially indicates an orientation corresponding to the direction in which the fishing rod 12, to which the fishing reel 11 is attached (refer to FIG. 2), faces. That is, the detection values of the positional sensor 43 indicate the orientations (directions) in which the tip of the fishing rod 12 points when the angler carries out casting and retrieving. The direction in which the tip of the fishing rod 12 points when the angler carries out casting indicates the casting direction of the lure 14. The direction in which the tip of the fishing rod 12 points when the angler carries out retrieval indicates the direction in which the lure 14 moves during retrieval. The detection value output by the positional sensor 43 corresponds to the "positional information indicating the position" described in the present disclosure.

The rotation sensor 42 is a so-called rotary encoder. The rotation sensor 42 has a first magnetic sensor 47 and a plurality of first magnets 26. The plurality of first magnets 26 are attached to the peripheral portion of the spool 22 at prescribed angular intervals.

The first magnetic sensor 47 is mounted on the printed circuit board 39 and is located close to the peripheral portion of the spool 22. Each of the first magnets 26 repeats an action of approaching the first magnetic sensor 47 and then moving away from the first magnetic sensor 47 as the spool 22 rotates. The first magnetic sensor 47 has a detection coil and detects magnetism (magnetic flux) that is changed by the plurality of first magnets 26 that move closer or farther away. The rotation sensor 42 outputs, as a detection value, a rectangular wave that changes at a period corresponding to the speed and direction of the rotation of the spool 22.

The wave count (rotational count), which is the number of rectangular waves output by the rotation sensor 42, indicates the number of rotations of the spool 22. The wave count (rotational count) per unit time indicates the rotational speed of the spool 22. A change in the interval between the rectangular waves indicates the direction of rotation of the spool 22. The direction of the rotation of the spool 22 changes between when a fishing line 13 is unreeled from the spool 22 (casting) and when the fishing line 13 is wound onto the spool 22 (retrieving). That is, the detection value of the rotation sensor 42 indicates the length of the fishing line 13 unreeled from the spool 22 and the length of the fishing line 13 wound onto the spool 22 during casting and retrieving, the speed of the lure 14 during casting, and the speed of the lure 14 during retrieval.

The lever detection sensor 44 includes a second magnetic sensor 48, and a second magnet 27. The second magnet 27 is directly attached to the clutch operation lever 24, or attached to a member that is displaced in conjunction with the clutch operation lever 24, and is displaced as the angler operates the clutch operation lever 24. The second magnetic sensor 48 is mounted on the printed circuit board 39. The second magnet 27 approaches the second magnetic sensor 48 or moves away from the second magnetic sensor 48 as the angler operates the clutch operation lever 24. The second magnetic sensor 48 has a detection coil and detects magnetism (magnetic flux) that is changed by the second magnet 27 that moves closer or farther away. The second magnetic sensor 48 outputs a detection value corresponding to an increase in the magnetic flux and a detection value corresponding to a decrease in the magnetic flux. That is, the lever detection sensor 44 detects the angler's operation of the clutch operation lever 24 and the type of operation. The types of operation are an operation of switching the clutch operation lever 24 from the engagement position to the disengagement position, and an operation of switching from the disengagement position to the engagement position.

The sensor group 40, the power switch 38, and the display 35 are electrically connected to the controller 31 (refer to FIG. 1) through a pattern on the printed circuit board 39.

### 3. Operation of fishing tackle 10 controller 31

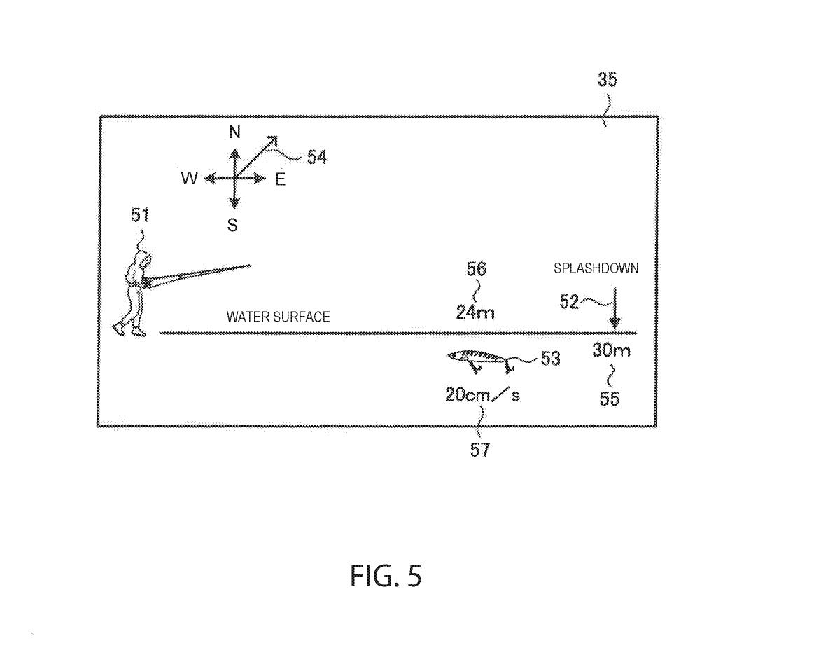

FIG. 4 shows a flowchart of a detection display process executed by the controller 31. FIG. 5 shows an assistance image displayed on the display 35.

The detection display process executed by the controller 31 is a process executed by the detection unit 30, and is also a process that the control program 34 causes the CPU 32 to execute.

The controller 31 starts the detection display process on the basis of the power switch 38 being turned on. First, the controller 31 periodically acquires, at prescribed time intervals, and stores in the memory 33, sensor detection values output by the sensor group 40 (S11). The prescribed time interval is the so-called sampling period, and is, for example, several tens to several hundreds of milliseconds.

The controller 31 determines whether the angler has carried out casting on the basis of the plurality of sensor detection values that have been acquired (S12). Specifically, the controller 31 determines whether the angler has operated the clutch operation lever 24 on the basis of the detection value of the lever detection sensor 44. When it is determined that the angler has operated the clutch operation lever 24, the controller 31 determines whether the fishing line 13 has been unreeled from the spool 22 on the basis of a detection value (rectangular wave) of the rotation sensor 42 after the clutch operation lever 24 was operated. When it is determined that the fishing line 13 has been unreeled from the spool 22, the controller 31 determines that the angler has carried out casting.

When it is determined that the angler has carried out casting (S12: Yes), the controller 31 calculates, and stores in the memory, the unreeled length of the fishing line 13 (S13). Specifically, the controller 31 calculates the unreeled length of the fishing line 13 on the basis of the circumferential length of the spool 22 and the wave count (rotational count) of the detection value (rectangular wave) of the rotation sensor 42 after the clutch operation lever 24 is operated. The circumferential length of the spool 22 is pre-stored in the memory 33. Alternatively, the memory 33 pre-stores a function for calculating the unreeled length of the fishing line 13. The controller 31 passes the wave count (rotational count) of the detection value (rectangular wave) of the rotation sensor 42 to the function as an argument, and receives the unreeled length of the fishing line 13 as a return value.

The controller 31 calculates, and stores in the memory 33, splashdown coordinates of the lure 14 on the basis of the orientation detected by the positional sensor 43 and the unreeled length calculated in step S13. For example, coordinates (x, y) are calculated as the splashdown coordinates in an xy coordinate system in which east is the x axis and north is the y axis. For example, when the direction detected by the positional sensor 43 is "northeast" and the unreeled length of the fishing line 13 is 30 m, (30 sin 45°, 30 cos 45°) are calculated as the splashdown coordinates. Note that the origin (0, 0) in the coordinate system is the location of the angler. The splashdown coordinates are one example of the "location information" and the "coordinate information" described in the present disclosure. The x coordinate axis and the y coordinate axis correspond to the "reference axes" described in the claims.

After executing the process of step S14, or when it is determined that the angler is not carrying out casting (S12: No), the controller 31 determines whether the angler has carried out retrieval (S15). Specifically, the controller 31 determines whether the angler has operated the clutch operation lever 24 on the basis of the detection value of the lever detection sensor 44. When it is determined that the angler has operated the clutch operation lever 24, the controller 31 determines whether the fishing line 13 has been wound onto the spool 13 on the basis of a detection value (rectangular wave) of the rotation sensor 42 after the clutch operation lever 24 was operated. When it is determined that the fishing line 13 has been wound onto the spool 22, the controller 13 determines that the angler has carried out retrieval.

When it is determined that the angler has carried out retrieval (S15: Yes), the controller 31 calculates, and stores in the memory 33, the current coordinates and the speed of the lure 14 (S16). Specifically, the controller 31 calculates the length of the fishing line 13 wound onto the spool 22 on the basis of the circumferential length of the spool 22 and the wave count (rotational count) of the detection value (rectangular wave) of the rotation sensor 42 after the clutch operation lever 24 is operated. Alternatively, the memory 33 pre-stores a function for calculating the wound length of the fishing line 13. The controller 31 passes the wave count (rotational count) of the detection value (rectangular wave) output by the rotation sensor 42 to the function as an argument, and receives the wound length of the fishing line 13 as a return value. The controller 31 calculates the current coordinates of the lure 14 on the basis of the unreeled length stored in the memory 33 in step S13, the calculated wound length, the swing of the fishing rod 12 indicated by the detection values of the acceleration sensor 41, and the orientation detected by the positional sensor 43. In addition, the controller 31 calculates the speed of the lure 14 on the basis of the wave count (rotational count) of the rectangular wave per unit time, as output by the rotation sensor 42. The current coordinates are one example of the "position information" and the "coordinate information" described in the present disclosure.

After executing the process of step S16, or when it is determined that the angler is not carrying out retrieval (S15: No), the controller 31 determines whether a fish has been hooked (S17). Specifically, the controller 31 determines that a fish has been hooked on the basis of the detection values of the acceleration sensor 41 indicating a sudden rapid acceleration of the fishing rod 12. Alternatively, the controller 31 determines that a fish has been hooked when the rotational direction of the spool 22 changes from the direction in which the fishing line 13 is wound up to the direction in which the fishing line 13 is unreeled.

When it is determined that a fish has not been hooked (S17: No), the controller 31 determines whether the reel 11 and/or fishing rod 12 is in "another state" in which the angler is neither casting nor retrieving (S18). Specifically, the controller 31 determines whether the angler has operated the clutch operation lever 24 on the basis of the detection value of the lever detection sensor 44. When it is determined that the angler is not operating the clutch operation lever 24, the controller 31 determines that the reel 11 and/or fishing rod 12 is in "another state." When it is determined that the reel 11 and/or fishing rod 12 are in another state (S18: Yes), the controller 31 executes the process from step S11 onward again. That is, the process of step S18 is a process for determining whether to update the assistance image. If it is not necessary to update the assistance image (S18: Yes), a new sensor detection value is acquired without newly generating image data (S11).

When it is determined that the reel 11 and/or fishing rod 12 is not in another state (S18: No), that is, when it is determined that the angler has carried out casting or retrieval, the controller 31 generates image data on the basis of the coordinates and the speed of the lure 14 stored in the memory 33 in step S14 or step S16 (S19).

The controller 31 inputs the generated image data to the display 35 and causes the display 35 to display the assistance image indicated by the image data (S20).

The assistance image shown in FIG. 5 includes an angler object 51 representing the angler, a splashdown position object 52 indicating the splashdown position of the lure 14, a lure object 53 representing the lure 14, an orientation object 54 indicating the orientation of the lure 14 relative to the angler, a numerical value 55 indicating the distance (casting distance) from the angler to the splashdown position, a numerical value 56 indicating the distance (separation distance) from the angler to the lure 14, and a numerical value 57 indicating the speed of the lure 14. The angler object 51 is located at the left end of the assistance image. The splashdown position object 52 is located at the right end of the assistance image. The lure object 53 is disposed at a location between the angler object 51 and the splashdown position object 52, and at a location corresponding to the current coordinates of the lure 14 stored in the memory 33 in step S16.

As shown in FIG. 4, when it is determined that a fish has been hooked in step S17 (S17: Yes), the controller 31 turns off the assistance image displayed on the display 35 to reduce energy consumption (S21).

After executing the process of step S20 or step S21, the controller 31 determines whether the angler has operated the power switch 38 to turn the power off (S22). When it is determined that the power has not been turned off (S22: No), the controller 31 executes the process from step S11 onward again. That is, the controller 31 repeatedly executes, over time, the process of step S19 for generating image data representing an assistance image and the process of step S20 for outputting the image data and displaying the assistance image on the display 35.

When it is determined that the power has been turned off (S22: Yes), the controller 31 ends the detection display process (End).

### 4. Lure fishing by an angler

An angler operates the clutch operation lever 24 to the disengagement position, and then swings or operates the fishing rod 12 to carry out casting. In other words, the angler casts the fishing rod 12. The cast causes the lure 14 to splash down at a position away from the angler. When the lure 14 splashes down, an assistance image is displayed on the display 35 including the angler object 51, the splashdown position object 52, the orientation object 54, and the numerical value 55 indicating the casting distance. The angler checks the casting direction and distance of the lure 14 from the angler object 51, the splashdown position object 52, the orientation object 54, and the numerical value 55 displayed in the assistance image. It should be noted that after the angler carries out casting but before carrying out retrieval, the lure object 53, the numerical value 56 indicating the distance to the lure 14, and the numerical value 57 indicating the speed of the lure 14, are not displayed in the assistance image.

After confirming the casting direction and distance of the lure 14 in the assistance image, the angler operates the clutch operation lever 24 to the engagement position, and then rotates the handle 25 to wind up the fishing line 13. In addition, the angler raises and lowers the fishing rod 12. With the rotation operation of the handle 25 and the raising and lowering of the fishing rod 12, the lure 14 approaches the angler at varying speeds. That is, action is generated in the lure 14. After the angler starts retrieval, the angler object 51, the splashdown position object 52, the orientation object 54, the numerical value 55 indicating the casting distance, the lure object 53, the numerical value 56 indicating the distance to the lure 14, and the numerical value 57 indicating the speed of the lure 14 are displayed in the assistance image. The angler carries out retrieval while visually checking the assistance image.

After retrieving the lure 14, the angler operates the clutch operation lever 24 to the disengagement position, and then swings or operates the fishing rod 12 to carry out casting again.

### 2. Action and effects of the first embodiment

The controller 31 calculates, and outputs over time, position coordinates indicating the location of the lure 14 on the basis of the detection values output by the sensor group 40. The position coordinates that are output over time indicate the behavior of the lure 14. That is, the fishing tackle 10 outputs, in real time, the behavior of the lure 14 in water. As a result, the fishing tackle 10 can improve the angler's catch results.

The acceleration sensor 41 outputs detection values corresponding to the swing of the fishing rod 12 by the angler during retrieval. The rotation sensor 42 detects a detection value corresponding to the rotation operation of the handle 25 by the angler. The controller 31 calculates the displacement of the lure 14 due to the raising and lowering of the fishing rod 12 on the basis of the detection values of the acceleration sensor 41, and calculates the displacement of the lure 14 due to the rotation operation of the handle 25 on the basis of the detection value of the rotation sensor 42. That is, by being provided with the acceleration sensor 41 and the rotation sensor 42, the fishing tackle 10 is able to accurately calculate the position coordinates of the lure 14 during retrieval.

By providing the positional sensor 43 on the fishing reel 11, the controller 31 is able to calculate the position coordinates of the lure 14 as coordinates in a coordinate system that uses the angler holding the fishing tackle 10 as a reference point and one of the cardinal directions (north, south, east, west) as the reference axis.

The display 35 that displays the location of the lure 14 is provided on the fishing reel 11. Accordingly, the angler is able to fish while checking the location and behavior of the lure 14 in water, without separately preparing a monitor.

### SECOND EMBODIMENT

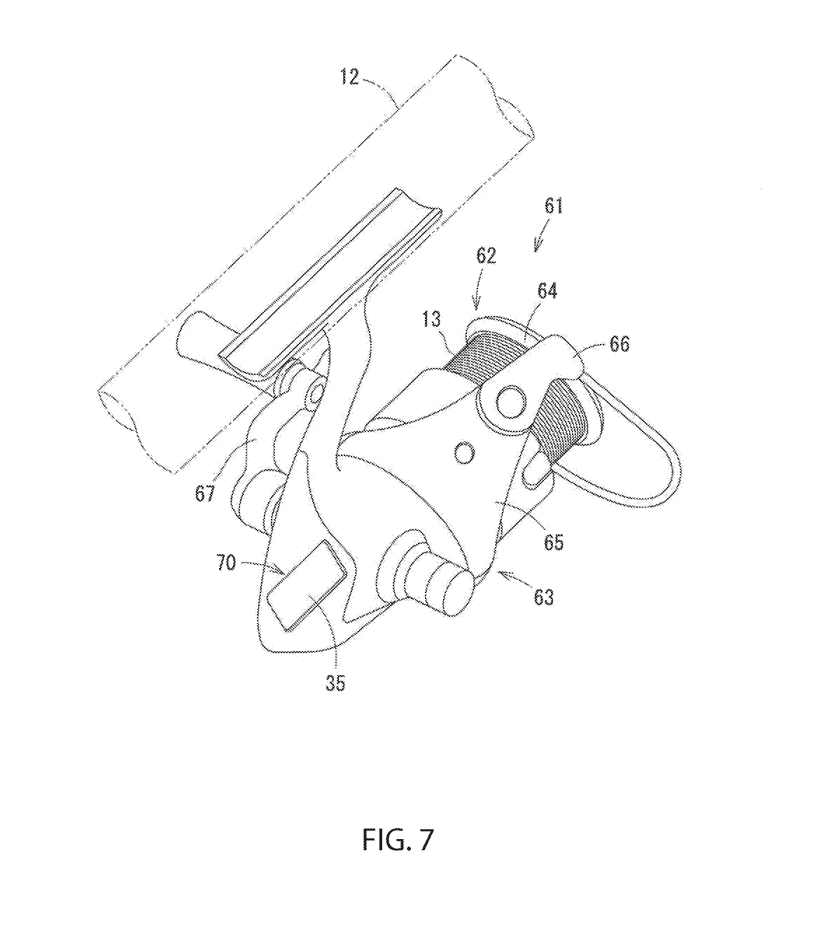

In the first embodiment, the fishing reel 11 that is a dual-bearing reel (bait reel) was described. In the second embodiment, a fishing reel 61 (refer to FIG. 7) that is a spinning reel will be described.

The configurations that are the same as those in the first embodiment have been assigned the same reference symbols as in the first embodiment, and the descriptions thereof will be omitted. In addition, the processes that are the same as those in the first embodiment are assigned the same step numbers as in the first embodiment, and the descriptions thereof will be omitted.

### 1. Overview and features

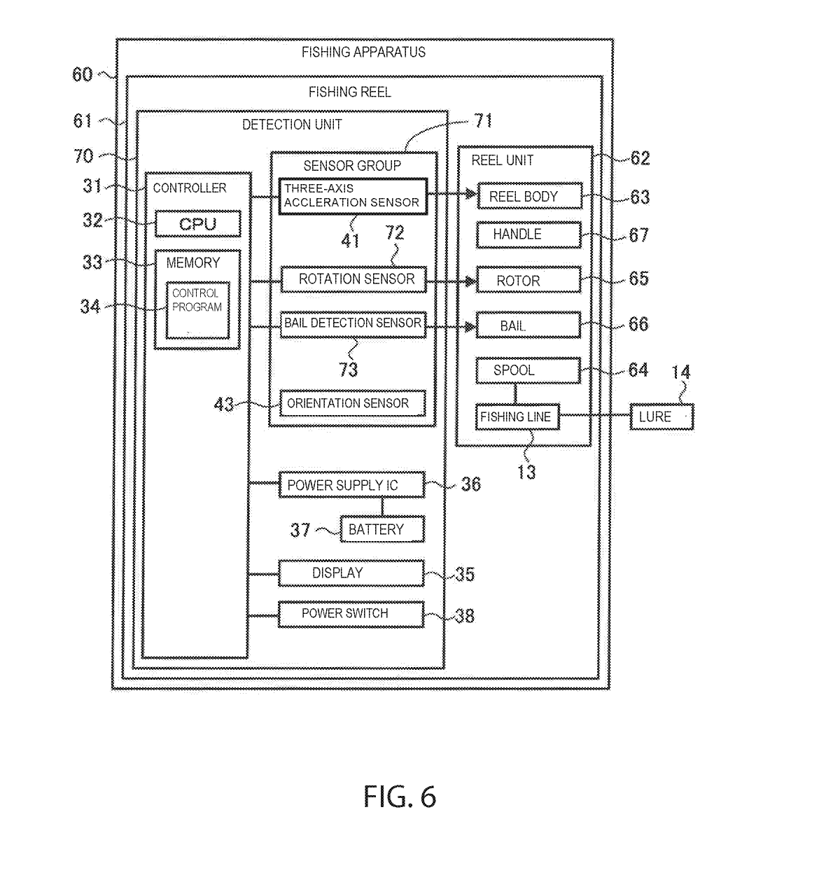

FIG. 6 is a functional block diagram of a fishing tackle 60 according to the second embodiment. FIG. 7 is a perspective view of the fishing reel 61.

The fishing tackle 60 is used for lure fishing, in which the lure 14 is cast and retrieved.

A characteristic feature of the fishing tackle 60 according to the present embodiment is that the fishing tackle 60 comprises a detection unit 70. The detection unit 70 detects the behavior of the fishing tackle 60 during casting and retrieving, estimates the behavior of the lure 14 from the detected behavior of the fishing tackle 60, and displays the estimated behavior of the lure 14 on the display 35. That is, the point of having a function to cause the angler to recognize the behavior of the lure 14 in water is the characteristic feature of the fishing tackle 60 according to the present embodiment.

### 2. Configuration of fishing tackle 60

In the present embodiment, the detection unit 70 is provided only on the fishing reel 61, which is a spinning reel, and the fishing rod 12 (refer to FIG. 7) is an existing fishing rod. The length and type of the fishing rod 12 are not particularly limited.

As shown in FIG. 6, the fishing reel 61 comprises a reel 62 and the detection unit 70.

The reel 62 is an existing fishing reel. That is, the fishing reel 61 is an existing reel (reel 62) to which the detection unit 70 is attached. However, the specifications of the reel 62 can be modified from those of an existing fishing reel in order to attach the detection unit 70.

The reel 62 is a so-called spinning reel in which a rotor 65 rotates around a spool 64. The reel 62 has a configuration similar to that of an existing fishing reel, comprising the reel body 63, the spool 64, the rotor 65, a bail 66, and a handle 67.

The reel body 63 shown in FIG. 7 supports the rotor 65 and the handle 67 so as to be rotatable. The rotational motion of the handle 67 is transmitted to the rotor 65 via a coupling mechanism (not shown). On the other hand, the bail 66 is supported by the rotor 65 so as to be able to turn (open and close) between an open position and a closed position. The angler puts the bail 66 in the open position, and then swings the fishing rod 12 to carry out casting. When casting, the fishing line 13 is unreeled from the spool 64. The angler puts the bail 66 in the closed position, and then rotates the handle 67 to carry out retrieval. During retrieval, the bail 66 rotates integrally with the rotor 65 and winds the fishing line 13 onto the spool 64.

As shown in FIG. 3, the detection unit 70 comprises the controller 31, the display 35, the power supply IC 36, the battery 37, the power switch 38, and a sensor group 71.

The sensor group 71 includes the acceleration sensor 41, a rotation sensor 72, the positional sensor 43, and a bail detection sensor 73.

The rotation sensor 72 has a third magnetic sensor (not shown) and a plurality of third magnets. The plurality of third magnets are attached to the rotor 65 at prescribed angular intervals and rotate integrally with the rotor 65. The attachment of the third magnets to the rotor 65 is the same as that of the first magnets 26 (refer to FIG. 3) to the spool 22.

The third magnetic sensor is mounted on a printed circuit board (not shown). The printed circuit board is fixed to the reel body 63. Each of the third magnets repeats an action of approaching the third magnetic sensor and then moving away from the third magnetic sensor as the rotor 65 rotates. The third magnetic sensor has a detection coil and detects magnetism (magnetic flux) that is changed by the plurality of third magnets that move closer or farther away. The rotation sensor 72 outputs, as a detection value, a rectangular wave that changes at a period corresponding to the rotation of the rotor 65. The wave count (rotational count), which is the number of rectangular waves output by the rotation sensor 72, indicates the number of rotations of the rotor 65. The wave count (rotational count) per unit time indicates the rotational speed of the rotor 65. That is, the detection value of the rotation sensor 72 indicates the length of the fishing line 13 wound onto the spool 64 during retrieval, and the speed (behavior) of the lure 14 during retrieval.

The bail detection sensor 73 has a fourth magnetic sensor (not shown) and a fourth magnet. The fourth magnet is directly attached to the bail 66, or attached to a member that is displaced together with the bail 66, and is displaced as the bail 66 is opened or closed (turned). The fourth magnetic sensor is mounted on the printed circuit board 39. The fourth magnet approaches or moves away from the fourth magnetic sensor as the bail 66 is opened or closed (turned). The fourth magnetic sensor has a detection coil and detects magnetism (magnetic flux) that is changed by the opening/closing of the bail 66. In addition, the fourth magnetic sensor outputs a different detection value depending on when the bail 66 is opened and when the bail 66 is closed. That is, the bail detection sensor 73 detects when the bail 66 is opened and when the bail 66 is closed.

The sensor group 71, the power switch 38, and the display 35 are electrically connected to the controller 31 through a pattern on the printed circuit board 39.

### 3. Operation of fishing tackle 30 controller 31

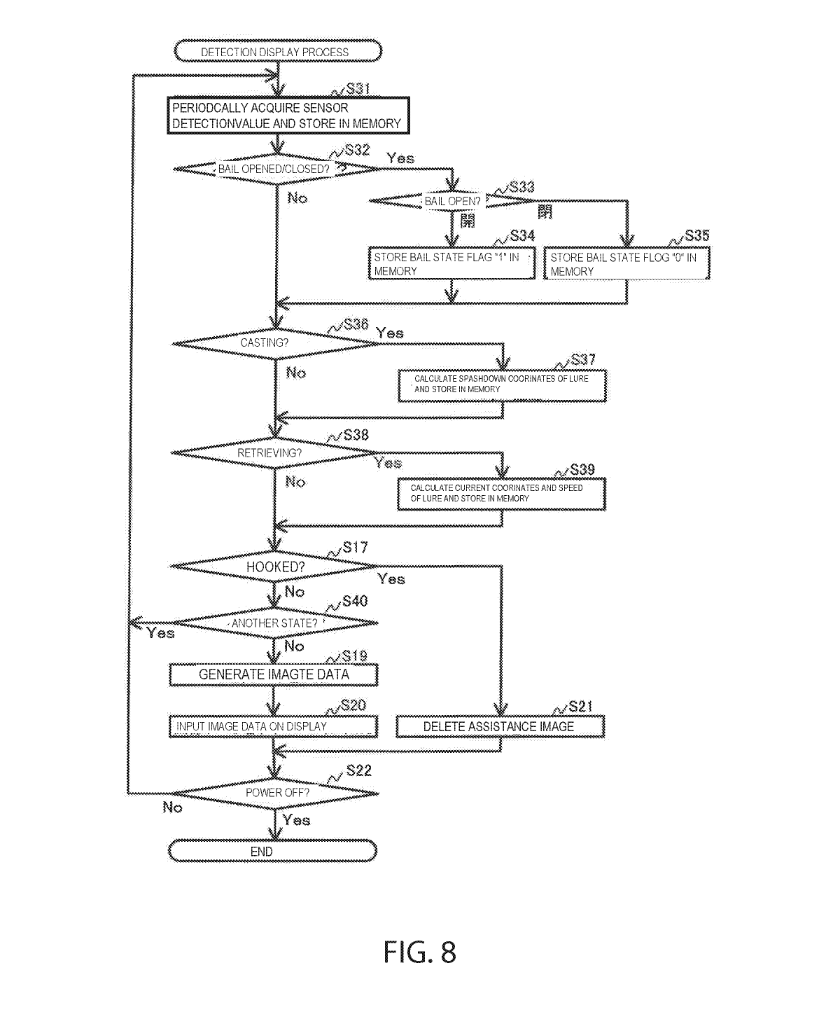

FIG. 8 shows a flowchart of a detection display process executed by the controller 31 in the present embodiment. That is, the controller 31 executes the detection display process shown in FIG. 8 instead of the detection display process shown in FIG. 4.

The detection display process executed by the controller 31 is a process executed by the detection unit 70, and is also a process that the control program 34 causes the CPU 32 to execute.

The controller 31 starts the detection display process on the basis of the power switch 38 being turned on. First, the controller 31 periodically acquires at prescribed time intervals, and stores in the memory 33, sensor detection values output by the sensor group 71 (S31). The prescribed time interval is the so-called sampling period, and is, for example, several tens to several hundreds of milliseconds.

The controller 31 determines whether the bail 66 has been opened or closed on the basis of a detection value output by the bail detection sensor 73 (S32). When it is determined that the bail 66 has been opened or closed (S32: Yes), the controller 31 determines whether the bail 66 was opened or closed on the basis of the detection value output by the bail detection sensor 73 (S33). When it is determined that the bail 66 was opened (S33: opened), the controller 31 stores, in the memory 33, a bail state flag of "1" indicating that the bail 66 is in the open state (S34). On the other hand, when it is determined that the bail 66 was closed (S33: closed), the controller 31 stores, in the memory 33, a bail state flag of "0" indicating that the bail 66 is in the closed state (S35).

The controller 31 determines whether the angler has carried out casting (S36). Specifically, the controller 31 determines whether the bail 66 is open or closed on the basis of the value of the bail state flag, and detects the acceleration generated in the fishing reel 11 due to the casting and retrieving of the angler on the basis of the detection values of the acceleration sensor 41. That is, the detection values of the acceleration sensor 41 indicate the strength with which, and the directions in which, the angler carried out casting and retrieving and generated acceleration in the fishing reel 11. In addition, the detection values of the acceleration sensor 41 also indicate the attitude of the fishing reel 11. It is determined whether the angler carried out casting, and whether the handle 67 has been rotated on the basis of the detection value of the rotation sensor 72. When it is determined that the bail 66 is open, that the fishing rod 12 was swung, and that the handle 67 is not being rotated, the controller 31 determines that the angler has carried out casting (S36: Yes).

When it is determined that the angler has carried out casting (S36: Yes), the controller 31 calculates, and stores in the memory 33, the splashdown coordinates of the lure 14 (S37). Specifically, the memory 33 pre-stores a function that takes three acceleration values, which are detection values of the acceleration sensor 41, as arguments and returns the casting distance of the lure 14 as the return value. The controller 31 passes the detection values of the acceleration sensor 41 as arguments to the function, and acquires the casting distance of the lure 14 as the return value. The controller 31 calculates the splashdown coordinates of the lure 14 on the basis of the acquired casting distance and the orientation detected by the positional sensor 43. For example, coordinates (x, y) are calculated as the splashdown coordinates in an xy coordinate system in which east is the x axis and north is the y axis. For example, when the direction detected by the positional sensor 43 is "northeast" and the acquired casting distance is 30 m, (30 sin 45°, 30 cos 45°) are calculated as the splashdown coordinates. Note that the origin (0, 0) in the coordinate system is the location of the angler. The splashdown coordinates correspond to the "location information" described in the claims.

After executing the process of step S37, or when it is determined that the angler is not carrying out casting (S36: No), the controller 31 determines whether the angler has carried out retrieval (S38). Specifically, the controller 31 determines whether the bail 66 is open or closed on the basis of the value of the bail state flag, determines whether casting has been carried out on the basis of the detection values of the acceleration sensor 41, and determines whether the handle 67 has been rotated on the basis of the detection value of the rotation sensor 72. When it is determined that the fishing rod 12 is being raised and lowered or that the handle 67 is being rotated in a state in which the bail 66 is closed, the controller 31 determines that the angler is carrying out retrieval (S38: Yes).

When it is determined that the angler is carrying out retrieval (S38: Yes), the controller 31 calculates, and stores in the memory, the current coordinates and the speed of the lure 14 (S39). Specifically, the controller 31 calculates the length of the fishing line 13 wound onto the spool 64 on the basis of the circumferential length of the spool 22 and the wave count (rotational count) of the detection value (rectangular wave) of the rotation sensor 22 after the bail 66 is closed. Alternatively, the memory 33 pre-stores a function for calculating the wound length of the fishing line 13. The controller 31 passes the wave count (rotational count) of the detection value (rectangular wave) output by the rotation sensor 72 to the function as an argument, and receives the wound length of the fishing line 13 as a return value. In addition, the controller 31 calculates the travel distance of the lure 14 due to the raising and lowering of the fishing rod 12 on the basis of the detection values of the acceleration sensor 41. The controller 31 calculates the current coordinates of the lure 14 on the basis of the splashdown coordinates stored in the memory 33 in step S37, the calculated wound length, the travel distance of the lure 14 due to the raising and lowering of the fishing rod 12, and the orientation detected by the positional sensor 43. In addition, the controller 31 calculates the speed of the lure 14 on the basis of the wave count (rotational count) of the rectangular wave per unit time, as output by the rotation sensor 72, and the raising and lowering of the fishing rod 12 as indicated by the detection values of the acceleration sensor 41.

After executing the process of step S39, or when it is determined that the angler is not carrying out retrieval (S38: No), the controller 31 determines whether a fish has been hooked (S17). For example, the controller 31 determines that a fish has been hooked on the basis of the detection values of the acceleration sensor 41 indicating a sudden, rapid acceleration of the fishing rod 12.

When it is determined that a fish has not been hooked (S17: No), the controller 31 determines whether the reel 11 and/or the fishing rod 12 is in "another state" in which the angler is neither casting nor retrieving (S40). Specifically, the controller 31 determines that the reel 11 and/or the fishing rod 12 is in "another state" when the bail 66 is not being opened or closed, the fishing rod 12 is not being swung, and the handle 67 is not being rotated. When it is determined that the reel 11 and/or the fishing rod 12 is in another state (S40: Yes), the controller 31 executes the process from step S11 onward again. That is, the process of step S18 is a process for determining whether to update the assistance image. If it is not necessary to update the assistance image (S18: Yes), a new sensor detection value is acquired without newly generating image data (S11).

When it is determined that the reel 11 and/or the fishing rod 12 is not in another state (S40: No), that is, when it is determined that the angler has carried out casting and/or retrieving, the controller 31 generates image data on the basis of the coordinates and the speed of the lure 14 stored in the memory 33 in step S37 or step S39 (S19).

The controller 31 inputs the generated image data to the display 35 and causes the display 35 to display the assistance image (refer to FIG. 5) indicated by the image data (S20).

When it is determined that a fish has been hooked in step S17 (S17: Yes), the controller 31 turns off the assistance image displayed on the display 35 to reduce energy consumption (S21).

After executing the process of step S20 or step S21, the controller 31 determines whether the angler has operated the power switch 38 to turn the power off (S22). When it is determined that the power has not been turned off (S22: No), the controller 31 executes the process from step S11 onward again. That is, the controller 31 repeatedly executes, over time, the process of step S19 for generating image data representing an assistance image and the process of step S20 for outputting the image data and displaying the assistance image on the display 35.

When it is determined that the power has been turned off (S22: Yes), the controller 31 ends the detection display process (End).

### 2. Lure fishing by an angler

The angler opens the bail 66, and then swings or operates the fishing rod 12 to carry out casting. The cast causes the lure 14 to splash down at a position away from the angler. When the lure 14 splashes down, an assistance image (refer to FIG. 5) is displayed on the display 35 including the angler object 51, the splashdown position object 52, the orientation object 54, and the numerical value 55 indicating the casting distance. The angler checks the casting direction and distance of the lure 14 from the angler object 51, the splashdown position object 52, the orientation object 54, and the numerical value 55 displayed in the assistance image. It should be noted that after the angler carries out casting but before carrying out retrieval, the lure object 53, the numerical value 56 indicating the distance to the lure 14, and the numerical value 57 indicating the speed of the lure 14, are not displayed in the assistance image.

After confirming the casting direction and distance of the lure 14 in the assistance screen, the angler operates the clutch operation lever 24 to the engagement position, and then rotates the handle 25 to wind up the fishing line 13. In addition, the angler raises and lowers the fishing rod 12. With the rotation operation of the handle 25 and the raising and lowering of the fishing rod 12, the lure 14 approaches the angler at varying speeds. That is, action is generated in the lure 14. After the angler starts retrieval, the angler object 51, the splashdown position object 52, the orientation object 54, the numerical value 55 indicating the casting distance, the lure object 53, the numerical value 55 indicating the distance to the lure 14, and the numerical value 57 indicating the speed of the lure 14 are displayed in the assistance image., The angler carries out retrieval while visually checking the assistance image.

After retrieving the lure 14, the angler opens the bail, and then swings the fishing rod 12 to carry out casting again.

### 5. Action and effects of the second embodiment

The controller 31 calculates, and outputs over time, position coordinates indicating the location of the lure 14 on the basis of the detection values output by the sensor group 71. The position coordinates that are output over time indicate the behavior of the lure 14. That is, the fishing tackle 60 outputs, in real time, the behavior of the lure 14 in water. As a result, the fishing tackle 60 can improve the angler's catch results.

The acceleration sensor 41 outputs detection values corresponding to the raising and lowering of the fishing rod 12 by the angler during retrieval. The rotation sensor 72 detects a detection value corresponding to the rotation operation of the handle 67 by the angler. The controller 31 calculates the displacement of the lure 14 due to the raising and lowering of the fishing rod 12 on the basis of the detection values of the acceleration sensor 41, and calculates the displacement of the lure 14 due to the rotation operation of the handle 67 on the basis of the detection value of the rotation sensor 72. That is, by being provided with the acceleration sensor 41 and the rotation sensor 72, the fishing tackle 10 is able to accurately calculate the position coordinates of the lure 14 during retrieval.

By providing the positional sensor 43 on the fishing reel 61, the controller 31 is able to calculate the position coordinates of the lure 14 as coordinates in a coordinate system that uses the angler holding the fishing tackle 60 as a reference point and a cardinal direction (north, south, east, west) as the reference axis.

The display 35 that displays the location of the lure 14 is provided on the fishing reel 61. Accordingly, the angler is able to fish while checking the location and behavior of the lure 14 in water, without separately preparing a monitor.

### THIRD EMBODIMENT

In the first embodiment, an example was described in which sensors are attached only to the fishing reel 11. In the present embodiment, an example is described in which sensors are attached to the fishing reel 11 and a fishing rod 81.

The configurations that are the same as those in the first embodiment have been assigned the same reference symbols as in the first embodiment, and the descriptions thereof will be omitted.

### 2. Overview and features

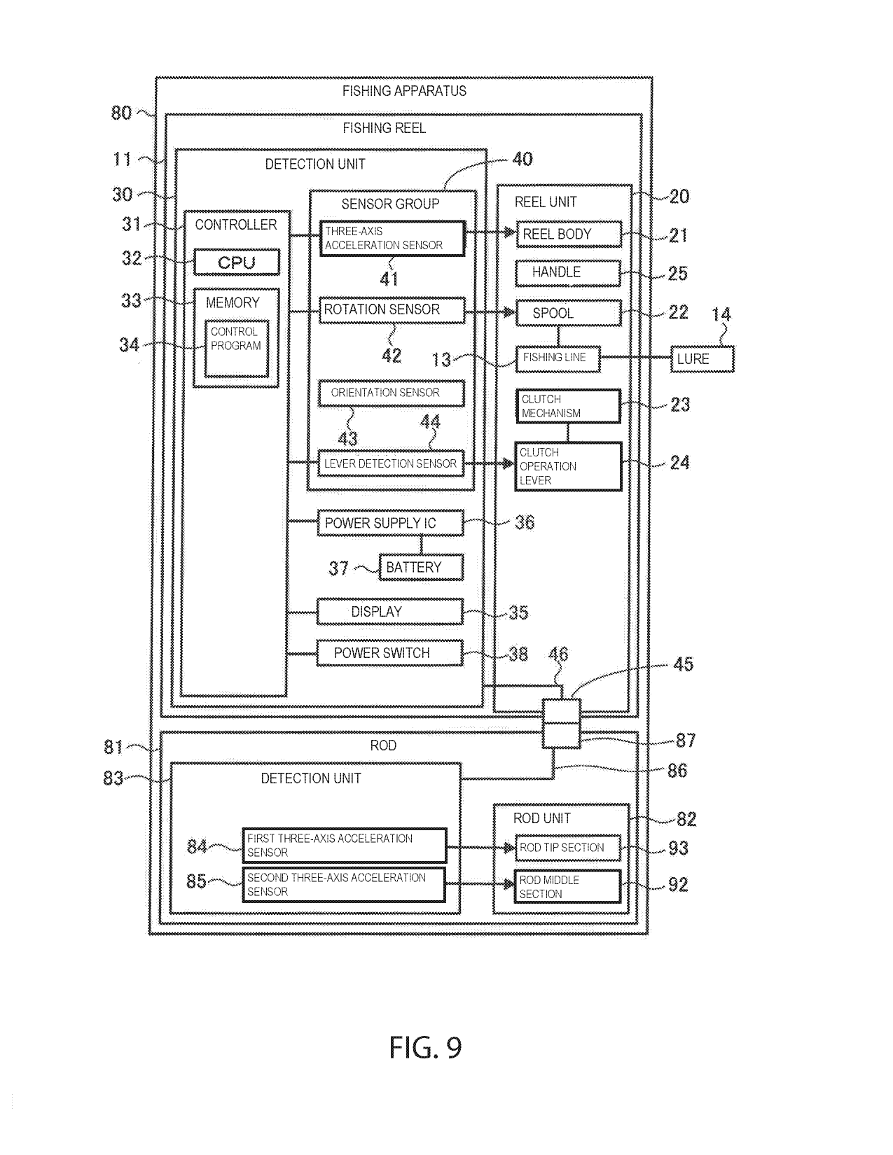

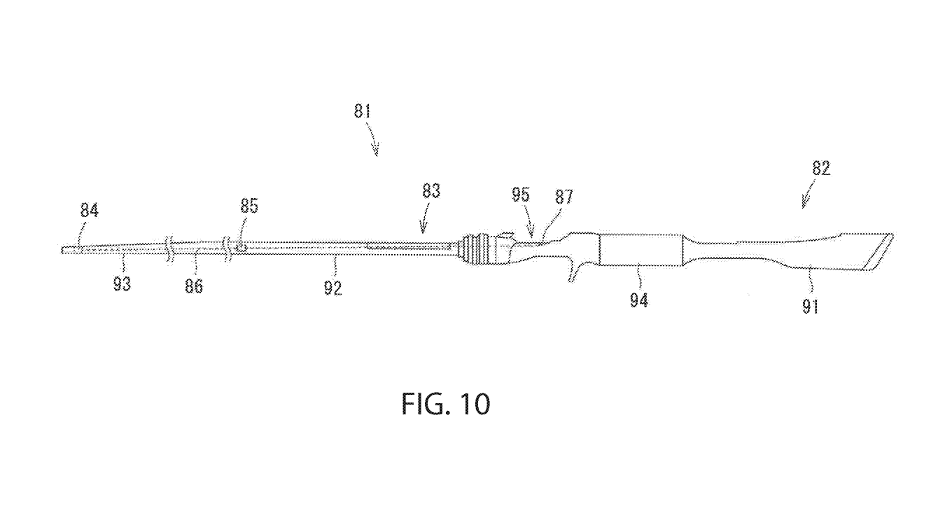

FIG. 9 is a functional block diagram of a fishing tackle 80 according to the third embodiment. FIG. 10 is a side view of the fishing rod 81.

The fishing tackle 80 shown in FIG. 9 is used for lure fishing in which the lure 14 is cast and retrieved.

A characteristic feature of the fishing tackle 80 according to the present embodiment is that the fishing tackle 80 comprises the detection unit 30 and a detection unit 83. The detection unit 30 and the detection unit 83 detect the behavior of the fishing tackle 80 during casting and retrieving, estimate the behavior of the lure 14 from the detected behavior of the fishing tackle 80, and display the estimated behavior of the lure 14 on the display 35. That is, the fishing tackle 80 according to the present embodiment has a function of allowing the angler to recognize the behavior of the lure 14 in water.

### 2. Configuration of fishing tackle 80

As shown in FIG. 9, the fishing tackle 80 according to the present embodiment comprises the fishing reel 11 and a fishing rod 81.

The fishing reel 11 comprises the reel 20 and the detection unit 30. The reel 20 further comprises a connection terminal 45. The connection terminal 45 is electrically connected to the detection unit 30 via a cable 46. The connection terminal 45 connects with (contacts) a connection terminal 87 provided on the fishing rod 81 to which the fishing reel 11 is set.

The fishing rod 81 comprises a fishing rod unit 82 and the detection unit 83.

The fishing rod unit 82 is an existing fishing rod. That is, the fishing rod 81 is an existing fishing rod (fishing rod unit 82) to which the detection unit 83 is attached. However, the specifications of the fishing rod unit 82 can be modified from those of an existing fishing rod in order to attach the detection unit 83. The length and type of the fishing rod unit 82 are not particularly limited.

As shown in FIG. 10, the fishing rod unit 82 comprises a rod end section 91, one or more rod middle sections 92, and a rod tip section 93. The rod end section 91 includes a grip 94 that is grasped by the angler, and a reel seat 95 to which the fishing reel 11 is attached.

As shown in FIGS. 9 and 10, the detection unit 83 comprises a first acceleration sensor 84 and a second acceleration sensor 85. The detection unit 83 is electrically connected to the connection terminal 87 by a cable 86. The connection terminal 87 is provided on the reel seat 95 and is connected to the connection terminal 45 of the fishing reel 11 that is attached to the reel seat 95. The cable 86 is disposed inside the fishing rod unit 82.

The DC voltage output by the power supply IC 36 is supplied to the first acceleration sensor 84 and the second acceleration sensor 85 via the cable 46, the connection terminal 45, the connection terminal 87, and the cable 86. In addition, the detection values output by the first acceleration sensor 84 and the second acceleration sensor 85 are input to the detection unit 30 via the cable 86, the connection terminal 87, the connection terminal 45, and the cable 46. That is, the detection unit 30 and the detection unit 83 can communicate with each other.

### 3. Operation of fishing tackle 80 controller 31

The controller 31 executes the detection display process shown in FIG. 4.

In step S11, the controller 31 also acquires the detection values of the first acceleration sensor 84 and the second acceleration sensor 85 in addition to the detection values of the sensor group 40. In step S12, the controller 31 determines whether casting has been carried out on the basis of the detection values of the sensor group 40 and the detection values of the first acceleration sensor 84 and the second acceleration sensor 85. In addition, in step S15, the controller 31 determines whether retrieval has been carried out on the basis of the detection values of the sensor group 40 and the detection values of the first acceleration sensor 84 and the second acceleration sensor 85.

In step S16, the controller 31 calculates the amount and speed of movement of the lure 14 when the angler raises and lowers the fishing rod 81 on the basis of the detection values of the sensor group 40 and the detection values of the first acceleration sensor 84 and the second acceleration sensor 85. Specifically, the memory 33 pre-stores a function that takes the detection values of the acceleration sensor 41, the first acceleration sensor 84, and the second acceleration sensor 85 as arguments and returns the amount and speed of movement of the lure 14 as return values. The controller 31 passes the detection values of the acceleration sensor 41, the first acceleration sensor 84, and the second acceleration sensor 85 acquired in step S11 as arguments to the function, and acquires the amount and speed of movement of the lure 14 as return values. The controller 31 calculates the overall amount and speed of movement of the lure 14 on the basis of the amount and speed of movement, and the amount and speed of movement of the lure 14 detected by the rotation sensor 42.

In step S17, the controller 31 determines whether a fish has been hooked on the basis of the detection values of the sensor group 40, the first acceleration sensor 84, and the second acceleration sensor 85. For example, the controller 31 determines that a fish has been hooked on the basis of the rod tip being rapidly deformed compared to the fishing reel 11.

### 4. Action and effects of the third embodiment

The controller 31 calculates, and outputs over time, position coordinates indicating the location of the lure 14 on the basis of the detection values of the sensor group 40, the first acceleration sensor 84, and the second acceleration sensor 85. The position coordinates that are output over time indicate the behavior of the lure 14. That is, the fishing tackle 80 outputs, in real time, the behavior of the lure 14 in water. As a result, the fishing tackle 80 can improve the angler's catch results.

In addition, since the controller 31 calculates the position coordinates indicating the location of the lure 14 on the basis of the detection values of the first acceleration sensor 84 and the second acceleration sensor 85 in addition to the detection values of the sensor group 40, the accuracy of the calculation of the position coordinates can be improved compared to when the position coordinates are calculated based only on the detection values of the sensor group 40.

The acceleration sensor 41, the first acceleration sensor 84, and the second acceleration sensor 85 output detection values corresponding to the raising and lowering of the fishing rod 12 by the angler during retrieval. The rotation sensor 72 detects a detection value corresponding to the rotation operation of the handle 67 by the angler. The controller 31 calculates the displacement of the lure 14 due to the raising and lowering of the fishing rod 12 on the basis of the detection values of the acceleration sensor 41, the first acceleration sensor 84, and the second acceleration sensor 85, and calculates the displacement of the lure 14 due to the rotation operation of the handle 67 on the basis of the detection value of the rotation sensor 72. That is, by being provided with the acceleration sensor 41, the first acceleration sensor 84, the second acceleration sensor 85, and the rotation sensor 72, the fishing tackle 80 is able to accurately calculate the position coordinates of the lure 14 during retrieval.

By providing the positional sensor 43 on the fishing reel 61, the controller 31 is able to calculate the position coordinates of the lure 14 as coordinates in a coordinate system that uses the angler holding the fishing tackle 80 as a reference point and a cardinal direction (north, south, east, west) as the reference axis.

The display 35 that displays the location of the lure 14 is provided on the fishing reel 61. Accordingly, the angler is able to fish while checking the location and behavior of the lure 14 in water, without separately preparing a monitor.

In the third embodiment, the fishing tackle 80 comprising the fishing reel 11 that is a dual-bearing reel (bait reel) and the fishing rod 81 were described. However, the fishing tackle 80 can be provided with the fishing reel 61 that is a spinning reel instead of the fishing reel 11.

In the third embodiment, an example was described in which the detection unit 30 and the detection unit 83 communicate with each other via the connection terminal 45 and the connection terminal 87. However, the detection unit 30 and the detection unit 83 can both be provided with a short-range wireless communication module and communicate with each other using short-range wireless communication such as NFC. In that case, the detection unit 83 can be provided with the battery 37 and the power supply IC 36, in the same manner as the detection unit 30.

In the third embodiment, an example was described in which the display 35 is provided on the fishing reel 11. However, the display 35 can be provided on the fishing rod 81 instead of the fishing reel 11. In that case, the display 35 provided on the fishing rod 81 is electrically connected to the detection unit 30 via the cable 46, the connection terminal 45, the connection terminal 87, and the cable 86.

In the third embodiment, an example was described in which the controller 31 is provided on the fishing reel 11. However, the controller 31 can be provided on the fishing rod 81 instead of the fishing reel 11. In that case, the power supply IC 36, the battery 37, and the power switch 38 can also be provided on the fishing rod 81 instead of the fishing reel 11.

### FOURTH EMBODIMENT

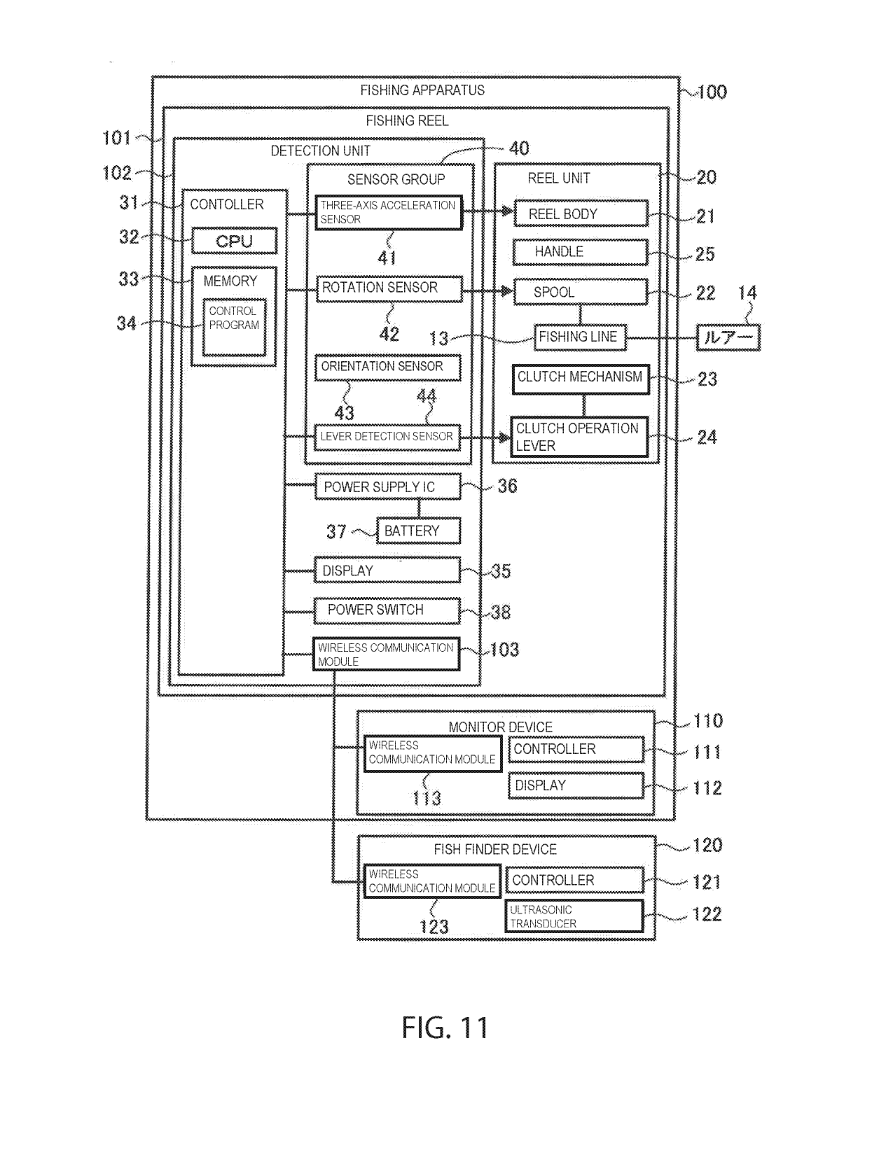

In the first, second, and third embodiments, examples were described in which the assistance image is displayed on the display 35 provided on the fishing reels 11 and 61. In the present embodiment, an example will be described in which a monitor device 110 (refer to FIG. 11) is used instead of the display 35.

The configurations that are the same as those in the first embodiment have been assigned the same reference symbols as in the first embodiment, and the descriptions thereof will be omitted. In addition, the processes that are the same as those in the first embodiment are assigned the same step numbers as in the first embodiment, and the descriptions thereof will be omitted.

### 1. Overview and features

FIG. 11 is a functional block diagram of a fishing tackle 100 according to the fourth embodiment.

The fishing tackle 100 shown in FIG. 11 is used for lure fishing in which the lure 14 is cast and retrieved.

A characteristic feature of the fishing tackle 100 according to the present embodiment is that the fishing tackle 100 comprises a detection unit 102 and the monitor device 110. The detection unit 102 detects the behavior of the fishing tackle 100 during casting and retrieving, estimates the behavior of the lure 14 from the detected behavior of the fishing tackle 100, and displays the estimated behavior of the lure 14 on a display 112 of the monitor device 110. That is, the fishing tackle 100 according to the present embodiment has a function of allowing the angler to recognize the behavior of the lure 14 in water.

### 2. Configuration of fishing tackle 100

The fishing tackle 100 comprises a fishing reel 101 and the monitor device 110. The fishing reel 101 is used attached to the fishing rod 12 (refer to FIG. 2). The fishing rod 12 is an existing fishing rod. The length and type of the fishing rod 12 are not particularly limited.

The fishing reel 101 comprises the reel 20 and the detection unit 102.

The detection unit 102 comprises the controller 31, the display 35, the power supply IC 36, the battery 37, the power switch 38, the sensor group 40, and a wireless communication module 103. The wireless communication module 103 corresponds to the "communication unit" described in the claims. In the present embodiment, wireless communication is exemplified, but it goes without saying that wired communication is also possible.

The wireless communication module 103 is a device that carries out short-range wireless communication with the monitor device 110. The wireless communication module 103 communicates with the monitor device 110 by NFC (Near Field Communication), for example. The wireless communication module 103 is one example of the "wireless communication unit" described in the present disclosure.

The wireless communication module 103, the sensor group 40, and the power switch 38 are electrically connected to the controller 31 through a pattern on the printed circuit board 39 (refer to FIG. 3).

The monitor device 110 is a device for displaying the image data that have been input. The monitor device 110 comprises a controller 111, the display 112, and a wireless communication module 113. The monitor device 110 and the display 112 are example of the "display unit" described in the present disclosure.

The wireless communication module 113 is a communication module that is able to carry out short-range wireless communication, such as NFC, with the wireless communication module 103 of the fishing reel 101 and a wireless communication module 123 of a fish finder device 120.

The fish finder device 120 is an existing device that detects schools of fish underwater. The fish finder device 120 comprises a controller 121, an ultrasonic transducer 122, and the wireless communication module 123. Any type of fish finder device can be used as the fish finder device 120, and the fish finder device 120 is not included in the fishing tackle 100. The monitor device 110 included in the fishing tackle 100 is typically not a device that accompanies the fish finder device 120, but is a commercially available product. The monitor device 110 can be a mobile terminal device such as a smartphone (registered trademark) or a tablet (registered trademark) carried by a user. However, a monitor device accompanying the fish finder device 120 can also be used as the monitor device 110.

### 3. Operation of fishing tackle 100 controller 31

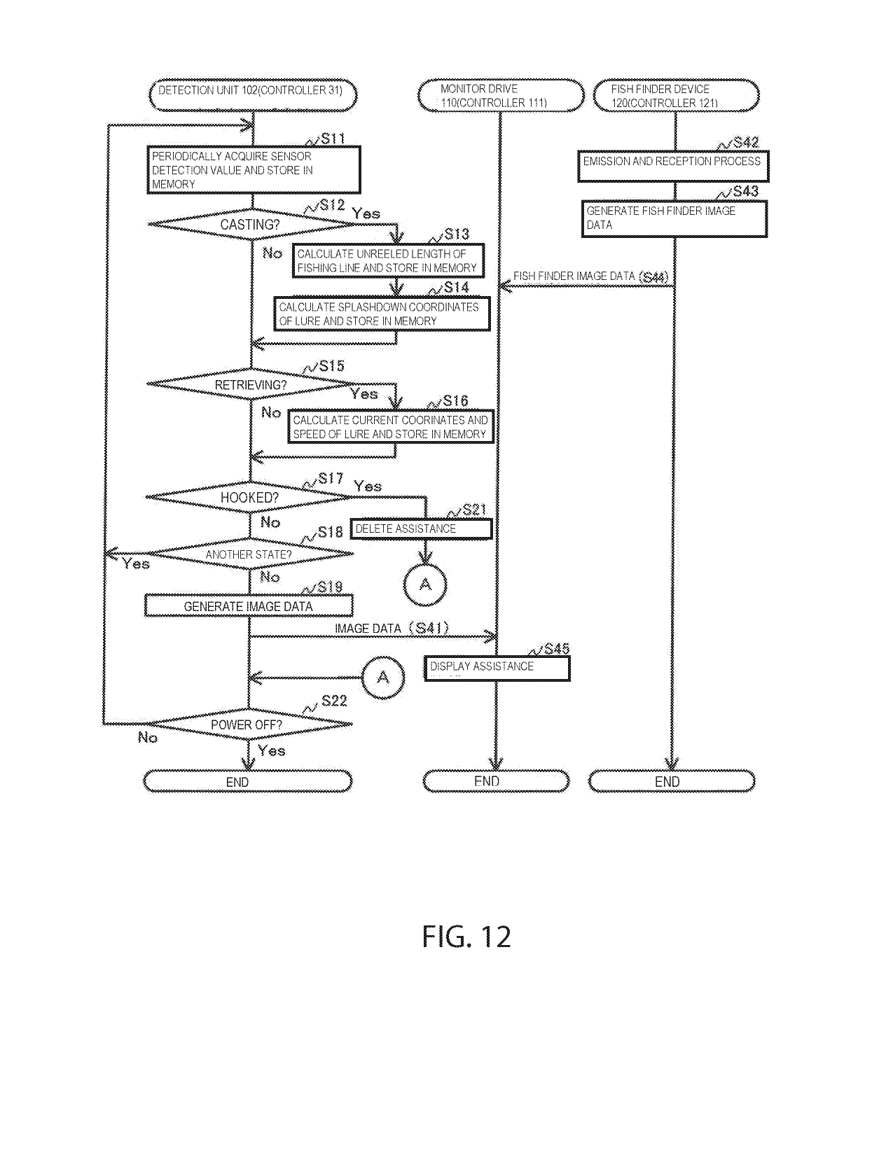

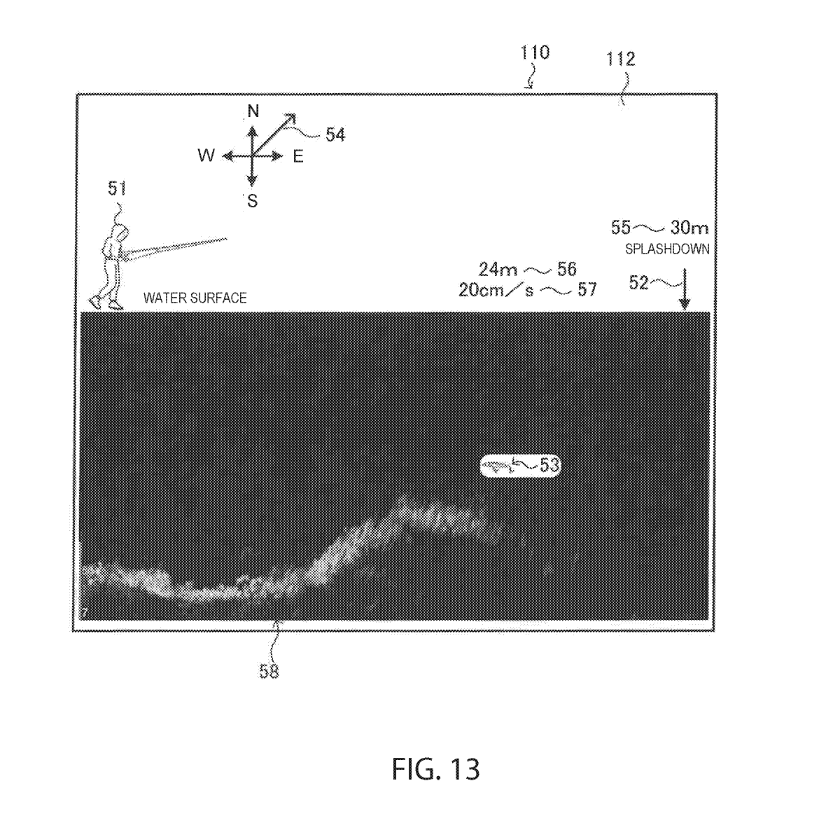

FIG. 12 shows a flowchart of a process executed by the controller 31 of the detection unit 102, the controller 111 of the monitor device 110, and the controller 121 of the fish finder device 120. FIG. 13 shows an assistance image displayed on the display 112 of the monitor device 110.

The process executed by the controller 31 is a process executed by the detection unit 102, and is also a process that the control program 34 causes the CPU 32 to execute. The process executed by the controller 111 is a process executed by the monitor device 110. The process executed by the controller 121 is a process executed by the fish finder device 120.

The controller 31 executes the process from step S11 to S19 and generates image data. The controller 31 transmits the generated image data to the monitor device 110 via the wireless communication module 103 (S41).

On the other hand, the controller 121 of the fish finder device 120 drives the ultrasonic transducer 122 to emit a sounding pulse and receives the reflected sound reflected from a school of fish, or the like (S42). The controller 121 generates fish finder image data on the basis of the received reflected sound (S43). The controller 121 transmits the generated fish finder image data to the monitor device 110 via the wireless communication module 123 (S44).

The controller 111 of the monitor device 110 receives the image data and the fish finder image data via the wireless communication module 113 (S41, S44). The controller 111 displays, on the display 112, an assistance image, which is an image obtained by superimposing an image represented by the image data received in step S41 onto the fish finder image represented by the fish finder image data received in step S44 (S45).

As shown in FIG. 13, the assistance image includes the angler object 51 representing the angler, the splashdown position object 52 indicating the splashdown position of the lure 14, the lure object 53 representing the lure 14, and the orientation object 54 indicating the casting direction of the lure 14. In addition, the assistance image includes a numerical value 55 indicating the casting distance of the lure 14, a numerical value 56 indicating the current separation distance from the angler to the lure 14, and a numerical value 57 indicating the instantaneous speed of the lure 14. The angler object 51, etc., are displayed in the assistance image based on the image data received in step S41. The lure object 53 corresponds to the "specific object" described in the claims.

The assistance image includes a fish school echo 58 indicating a school of fish. The fish school echo 58 is displayed in the assistance image based on the fish finder image data received in step S44.

### 4. Lure fishing by an angler

An angler operates the clutch operation lever 24 to the disengagement position, and then swings the fishing rod 12 to carry out casting. The cast causes the lure 14 to splash down at a position away from the angler. When the lure 14 splashes down, the angler object 51, the splashdown position object 52, the lure object 53, and the orientation object 54 are displayed on the display 35, together with the fish school echo 58. The angler operates the handle 25 to carry out retrieval while ascertaining the positional relationship between the school of fish indicated by the fish school echo 58 and the lure 14 indicated by the lure object 53.

### 5. Action and effects of the fourth embodiment

The controller 31 calculates, and outputs over time, position coordinates indicating the location of the lure 14 on the basis of the detection values output by the sensor group 40. The position coordinates that are output over time indicate the behavior of the lure 14. That is, the fishing tackle 100 outputs, in real time, the behavior of the lure 14 in water. As a result, the fishing tackle 100 can improve the angler's catch results.

The acceleration sensor 41 outputs detection values corresponding to the raising and lowering of the fishing rod 12 by the angler during retrieval. The rotation sensor 42 detects a detection value corresponding to the rotation operation of the handle 25 by the angler. The controller 31 calculates the displacement of the lure 14 due to the raising and lowering of the fishing rod 12 on the basis of the detection values of the acceleration sensor 41, and calculates the displacement of the lure 14 due to the rotation operation of the handle 25 on the basis of the detection value of the rotation sensor 42. That is, by being provided with the acceleration sensor 41 and the rotation sensor 42, the fishing tackle 100 is able to accurately calculate the position coordinates of the lure 14 during retrieval.

By providing the positional sensor 43 on the fishing reel 101, the controller 31 is able to calculate the position coordinates of the lure 14 as coordinates in a coordinate system that uses the angler holding the fishing tackle 100 as a reference point and a cardinal direction (north, south, east, west) as the reference axis.

Since the wireless communication module 103 is provided on the fishing reel 101, it is possible to allow the angler to check the assistance image without providing a display in the fishing tackle 100.

Since the lure object 53 indicating the lure 14 is displayed in the assistance image together with the fish school echo 58, the angler is able to fish while checking the location of the lure 14 with respect to the school of fish.

### Modified Example of the fourth embodiment

In the fourth embodiment, an example was described in which the fishing tackle 100 comprises the fishing reel 101 and the monitor device 110. However, the fishing tackle 100 can comprise the fishing reel 101, the fishing rod 12, and the monitor device 110, comprise only the fishing reel 101, or comprise the fishing reel 101 and the fishing rod 12.

In the fourth embodiment, an example was described in which the controller 31 of the detection unit 102 calculates the position coordinates of the lure 14 on the basis of the detection values of the sensor group 40, and generates image data in step S19. However, the image data can be generated by the controller 111 of the monitor device 110. In that case, the controller 31 of the detection unit 102 transmits the sensor detection values acquired in step S11 to the monitor device 110 via the wireless communication module 103. The controller 111 of the monitor device 110 executes the process from step S12 to S19 and acquires image data on the basis of the sensor detection values that have been received. In that case, the controller 31 of the detection unit 102 and the controller 111 of the monitor device 110 correspond to the "calculation unit" described in the claims.

### FIFTH EMBODIMENT

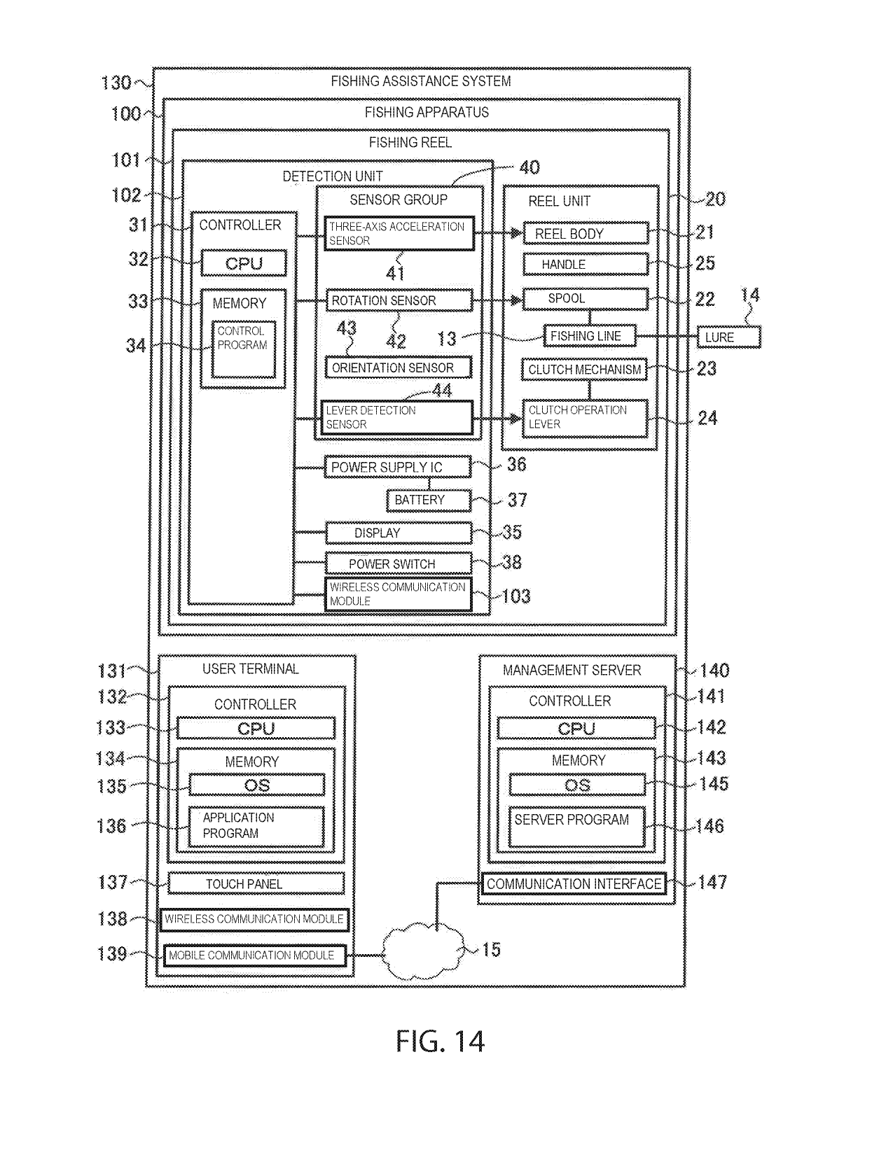

In the first, second, third, and fourth embodiments, the fishing tackle 10, 60, 80, and 100 according to the present embodiment were described. In the present embodiment, a fishing assistance system 130 (refer to FIG. 14) including the fishing tackle 100 is described.

The configurations that are the same as those in the first and fourth embodiments have been assigned the same reference symbols as in the first and fourth embodiments, and the descriptions thereof will be omitted. In addition, the processes that are the same as those in the first and fourth embodiments are assigned the same step numbers as in the first and fourth embodiments, and the descriptions thereof will be omitted.

### 1. Overview and features

FIG. 14 is a functional block diagram of a fishing assistance system 130 according to the fifth embodiment.

The fishing assistance system 130 is used for lure fishing in which the lure 14 is cast and retrieved.

A characteristic feature of the fishing assistance system 130 according to the present embodiment is that the fishing assistance system 130 comprises a detection unit 102, an application program 136 (hereinafter referred to as app 136), and a management server 140. The fishing assistance system 130 detects the behavior of the fishing tackle 100 during casting and retrieving, estimates the behavior of the lure 14 from the detected behavior of the fishing tackle 100, and displays the estimated behavior of the lure 14 on a touch panel 137 of the user terminal 131. That is, the fishing assistance system 130 according to the present embodiment has a function of allowing the angler to recognize the behavior of the lure 14 in water.

### 2. Configuration of the fishing assistance system 130

The fishing assistance system 130 comprises the fishing tackle 100, the app 136 installed on the user terminal 131, and the management server 140.

The user terminal 131 is a mobile communication terminal, such as a smartphone. The user terminal 131 comprises a controller 132, the touch panel 137, a wireless communication module 138, and a mobile communication module 139.

The controller 132 includes memory 134 and a CPU 133, which is a central processing unit.

The memory 134 stores an OS 135, which is an operating system, and the app 136. The OS 135 and the app 136 are executed by the CPU 133. The app 136 is downloaded from a website operated, for example, by the manufacturer of the fishing tackle 100 and onto the user terminal 131. The CPU 133 executing the app 136 is one example of the "computer" described in the present disclosure.

The touch panel 137 includes a display and a transparent, film-like touch sensor superimposed on the display. The touch panel 137 is one example of the "display unit" described in the present disclosure.

The wireless communication module 138 is a module that uses short-range wireless communication, such as NFC, to carry out wireless communication with the wireless communication module 103 of the fishing reel 101. The wireless communication module 138 is one example of the "first communication unit" described in the present disclosure.

The mobile communication module 139 is a module for communicating with the management server 140 via a mobile communication network and the Internet 15. The mobile communication module 139 is one example of the "first communication unit" described in the present disclosure.

The management server 140 is a web server that publishes communication addresses, such as URLs, on the Internet 15. The management server 140 is a server operated by the manufacturer of the fishing tackle 100, for example.

The management server 140 comprises a server controller 141 and a communication interface 147. The server controller 141 includes memory 143 and a CPU 142, which is a central processing unit. The memory 143 stores an OS 145, which is an operating system, and a server program 146. The OS 145 and the server program 146 are executed by the CPU 142. The communication interface 147 is connected to the Internet 15. The communication interface 147 is one example of the "second communication unit" described in the present disclosure. The server controller 141 is one example of the "server controller" described in the present disclosure.

The server controller 141 of the management server 140 and the app 136 of the user terminal 131 is one example of the "calculation unit" described in the present disclosure.

### 3. Operation of fishing tackle 100, user terminal 131, and management server 140

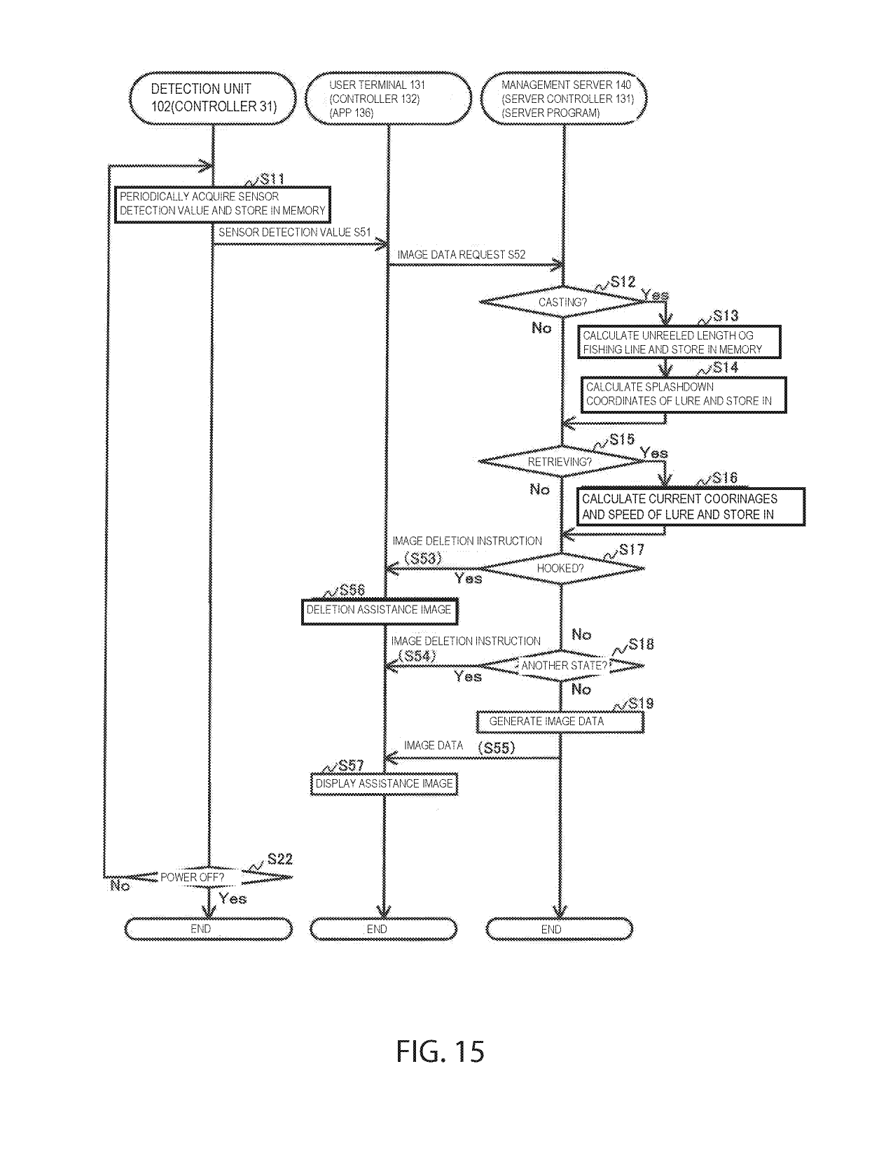

FIG. 15 shows a flowchart of a process executed by the controller 31 of the detection unit 102, the app 136 of the controller 132 of the user terminal 131, and the server program 146 of the server controller 141 of the management server 140.

The process executed by the controller 31 is a process executed by the detection unit 102, and is also a process that the control program 34 causes the CPU 32 to execute. The process executed by the controller 132 is a process executed by the user terminal 131, and is also a process that the app 136 causes the CPU 133 to execute. The process executed by the server controller 141 is a process executed by the management server 140, and is also a process that the server program 146 causes the CPU 142 to execute.

The controller 31 of the fishing reel 101 periodically acquires sensor detection values output by the sensor group 40 (S11). The controller 31 transmits the acquired sensor detection values to the user terminal 131 via the wireless communication module 103 (S51).

The controller 132 of the user terminal 131 transmits the sensor detection values via the wireless communication module 138 (S51). The controller 132 transmits the sensor detection values that have been received and a data request including an image data request to the management server 140 via the mobile communication module 139 and the Internet 15 (S52). The image data request is, for example, a command. The data request is a request corresponding to the HTTP or HTTPS communication protocol, i.e., a so-called HTTP request.

The server controller 141 of the management server 140 receives the sensor detection values and the data request including the image data request via the communication interface 147 (S52). The server controller 141 executes the process from step S12 to S19 on the basis of the sensor detection values that have been received. The process of steps S14 and S16 executed by the server controller 141 corresponds to the "location information calculation process" described in the claims.

When it is determined that a fish has been hooked in step S17 (S17: Yes), the server controller 141 responds with a data response including an image deletion instruction as a response to the data request received in step S52 to the user terminal 131 via the communication interface 147 and the Internet 15 (S53). The image deletion instruction is an instruction indicating to delete the assistance image currently displayed on the touch panel 137. The image deletion instruction is, for example, a command. The data response is a so-called HTTP response.

The controller 132 of the user terminal 131 receives a data response including an image deletion instruction via the mobile communication module 139 (S53). The controller 132 deletes the assistance image from the touch panel 137 on the basis of the image deletion instruction that has been received (S56).

When it is determined that the reel 11 and/or the fishing rod 12 is in "another state" in which the angler is carrying out neither casting nor retrieval in step S18 (S18: Yes), the server controller 141 responds with a data response including an image maintenance instruction as a response to the data request received in step S52, to the user terminal 131 via the communication interface 147 and the Internet 15 (S54). The image maintenance instruction is an instruction indicating to maintain the assistance image that is currently displayed on the touch panel 137. The image maintenance instruction is, for example, a command.

The server controller 141 responds with a data response including image data generated in step S19 as a response to the data request received in step S52, to the user terminal 131 via the communication interface 147 and the Internet 15 (S55). The process of step S55 is one example of the "image data response process" described in the present disclosure.

The controller 132 of the user terminal 131 receives a data response including image data via the mobile communication module 139 (S55). The controller 132 causes the touch panel to display the assistance image (refer to FIG. 4) indicated by the received image data. The process of step S57 is one example of the "display process" described in the present disclosure.

The controller 31 of the detection unit 102 of the fishing reel 101 periodically and repeatedly executes the process from step S11 onward until the angler turns the power off (S22: No).

### 4. Lure fishing by an angler

Prior to actual fishing, the angler activates the app 136 on the user terminal 131 carried by the user. The activated app 136 communicates with the fishing reel 101.

An angler operates the clutch operation lever 24 to the disengagement position, and then swings the fishing rod 12 to carry out casting. The cast causes the lure 14 to splash down at a position away from the angler. When the lure 14 splashes down, an assistance image including the angler object 51, the splashdown position object 52, the lure object 53, the orientation object 54, and the like, is displayed on the touch panel 137 of the user terminal 131. It should be noted that after the angler carries out casting but before carrying out retrieval, the lure object 53, the numerical value 56 indicating the distance to the lure 14, and the numerical value 57 indicating the speed of the lure 14, are not displayed in the assistance image.

After confirming the casting direction and distance of the lure 14 in the assistance screen, the angler operates the clutch operation lever 24 to the engagement position, and then rotates the handle 25 to wind up the fishing line 13. In addition, the angler raises and lowers the fishing rod 12. With the rotation operation of the handle 25 and the raising and lowering of the fishing rod 12, the lure 14 approaches the angler at varying speeds. That is, action is generated in the lure 14. After the angler starts retrieval, the angler object 51, the splashdown position object 52, the orientation object 54, the numerical value 55 indicating the casting distance, the lure object 53, the numerical value 55 indicating the distance to the lure 14, and the numerical value 57 indicating the speed of the lure 14 are displayed in the assistance image. The angler carries out retrieval while visually checking the assistance image.

After retrieving the lure 14, the angler operates the clutch operation lever 24 to the disengagement position, and then swings the fishing rod 12 to carry out casting again.

### 5. Action and effects of the fifth embodiment

The controller 31 calculates, and outputs over time, position coordinates indicating the location of the lure 14 on the basis of the detection values output by the sensor group 40. The position coordinates that are output over time indicate the behavior of the lure 14. That is, the fishing tackle 10 outputs, in real time, the behavior of the lure 14 in water. As a result, the fishing assistance system 130 can improve the angler's catch results.

The acceleration sensor 41 outputs detection values corresponding to the raising and lowering of the fishing rod 12 by the angler during retrieval. The rotation sensor 42 detects a detection value corresponding to the rotation operation of the handle 25 by the angler. The controller 31 calculates the displacement of the lure 14 due to the raising and lowering of the fishing rod 12 on the basis of the detection values of the acceleration sensor 41, and calculates the displacement of the lure 14 due to the rotation operation of the handle 25 on the basis of the detection value of the rotation sensor 42. That is, by being provided with the acceleration sensor 41 and the rotation sensor 42, the fishing tackle 10 is able to accurately calculate the position coordinates of the lure 14 during retrieval.

By providing the positional sensor 43 on the fishing reel 101, the controller 31 is able to calculate the position coordinates of the lure 14 as coordinates in a coordinate system that uses the angler holding the fishing tackle 100 as a reference point and a cardinal direction (north, south, east, west) as the reference axis.

Since the wireless communication module 103 is provided on the fishing reel 101, it is possible to allow the angler to check the assistance image without providing a display in the fishing tackle 100.

The assistance image is displayed on the touch panel 137 of the user terminal 131. Accordingly, it is not necessary to provide a display on the fishing reel 101 or the fishing rod 12.

The controller 132 provided on the fishing reel 101 executes only a process of periodically transmitting sensor detection values to the user terminal 131 (S51). Accordingly, the configuration of the detection unit 102 can be simplified.

In the fifth embodiment, an example was described in which the app 136 is not included in the fishing tackle 100. However, the app 136 can be included in the fishing tackle 100. That is, the app 136 can be provided to the angler with the purchase of the fishing tackle 100.

In the fifth embodiment, an example was described in which the fishing assistance system 130 comprises the fishing tackle 100, the app 136 installed on the user terminal 131, and the management server 140. However, the fishing assistance system 130 can comprise the fishing tackle 100, the user terminal 131 in which the app 136 is installed, and the management server 140.

In the fifth embodiment, an example was described in which the fishing assistance system 130 comprises the fishing tackle 100. However, the fishing assistance system 130 can comprise the fishing tackle 10, the fishing tackle 60, or the fishing tackle 80, instead of the fishing tackle 100.

The user terminal 131 can comprise a GPS (CNSS) transceiver antenna. The controller 132 (app 136) of the user terminal 131 transmits, to the management server 140, a data request including latitude and longitude information, which is GPS (GNSS) location information, in addition to the sensor detection values, in step S52. The server controller 141 of the management server 140 calculates the location of the angler and the location of the lure 14 as latitude and longitude information on the basis of the sensor detection values and the GPS (GNSS) location information and generates image data, in step S19.

The app 136 can accept input of the type of the fishing rod 12, the type of the fishing reel 11, or the type of the lure 14. The type of the fishing rod 12 is information from which the length and properties of the fishing rod 12 can be obtained, such as the model number of the fishing rod 12. The type of the fishing reel is information from which the circumferential length and properties of the spool 22 can be obtained, such as the model number of the fishing reel 11. The type of the lure 14 is information from which the size and weight of the lure can be obtained, such as the model number of the lure 14. The app 136 transmits, to the management server 140, the types of the fishing rod 12, the fishing reel 11, and the lure 14 that have been input. The server controller 141 of the management server 140 calculates the location of the lure 14 on the basis of the types of the fishing rod 12, the fishing reel 11, and the lure 14, in addition to the sensor detection values. As a result, the calculation accuracy of the location of the lure 14 further improves.

### SIXTH EMBODIMENT

In the fifth embodiment, a fishing assistance system 130 comprising the fishing tackle 100, the app 136 installed on the user terminal 131, and the management server 140 was described. In the present embodiment, a fishing assistance system 150 comprising the fishing tackle 100 and the app 136 installed on the user terminal 131 will be described.

The configurations that are the same as those in the first, fourth, and fifth embodiments have been assigned the same reference symbols as in the first, fourth, and fifth embodiments, and the descriptions thereof will be omitted. In addition, the processes that are the same as those in the first, fourth, and fifth embodiments are assigned the same step numbers as in the first, fourth, and fifth embodiments, and the descriptions thereof will be omitted.

### 1. Overview and features

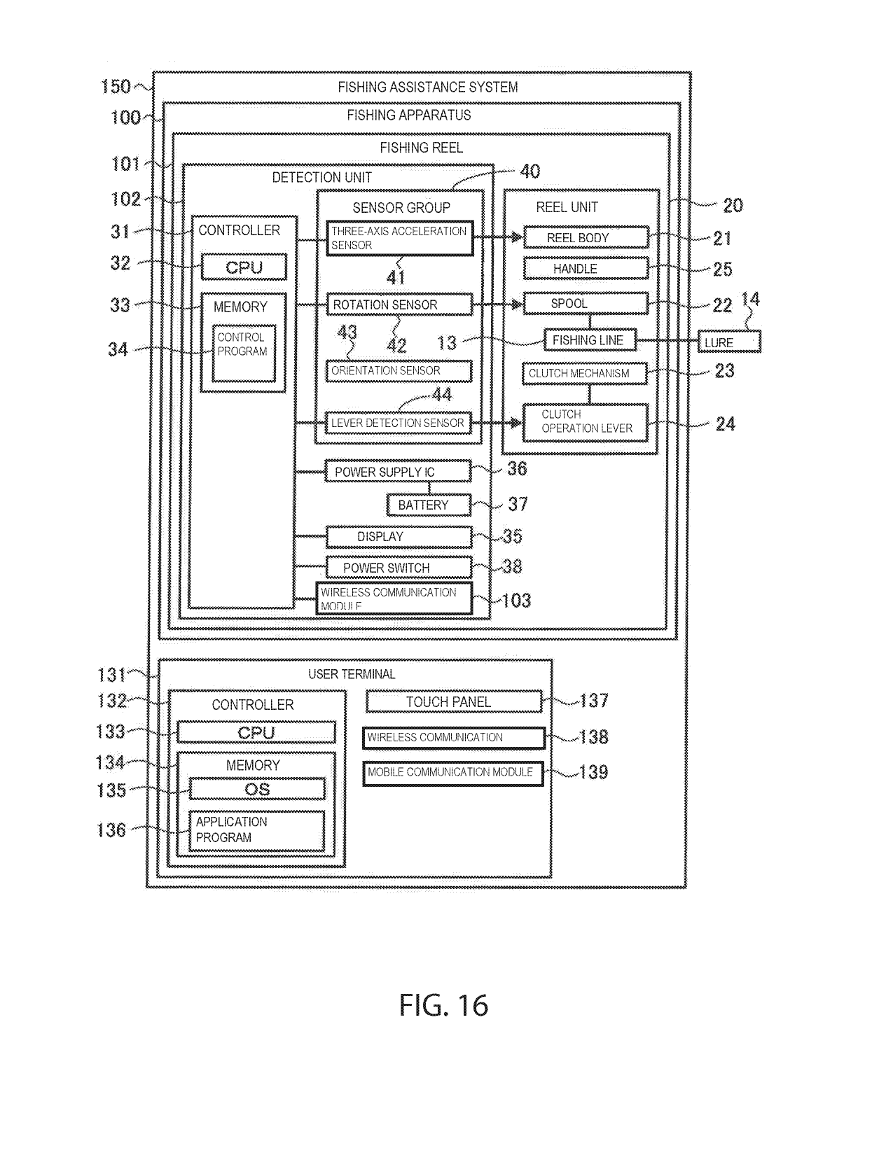

FIG. 16 is a functional block diagram of the fishing assistance system 150 according to the sixth embodiment.

The fishing assistance system 150 is used for lure fishing in which the lure 14 is cast and retrieved.

A characteristic feature of the fishing assistance system 150 according to the present embodiment is that the fishing assistance system 150 comprises the detection unit 102 and the app 136. The fishing assistance system 150 detects the behavior of the fishing tackle 100 during casting and retrieving, estimates the behavior of the lure 14 from the detected behavior of the fishing tackle 100, and displays the estimated behavior of the lure 14 on the touch panel 137 of the user terminal 131. That is, the fishing assistance system 150 according to the present embodiment has a function of allowing the angler to recognize the behavior of the lure 14 in water.

### 2. Configuration of the fishing assistance system 150

The fishing assistance system 150 comprises the fishing tackle 100, and the app 136 installed on the user terminal 131.

The wireless communication module 138 of the user terminal 131 is one example of the "communication unit" described in the present disclosure. The touch panel 137 of the user terminal 131 is one example of the "display unit" described in the present disclosure. The CPU 133 of the user terminal 131 is one example of the "computer" described in the present disclosure. The wireless communication module 138 of the user terminal 131 is one example of the "reception unit" described in the present disclosure.

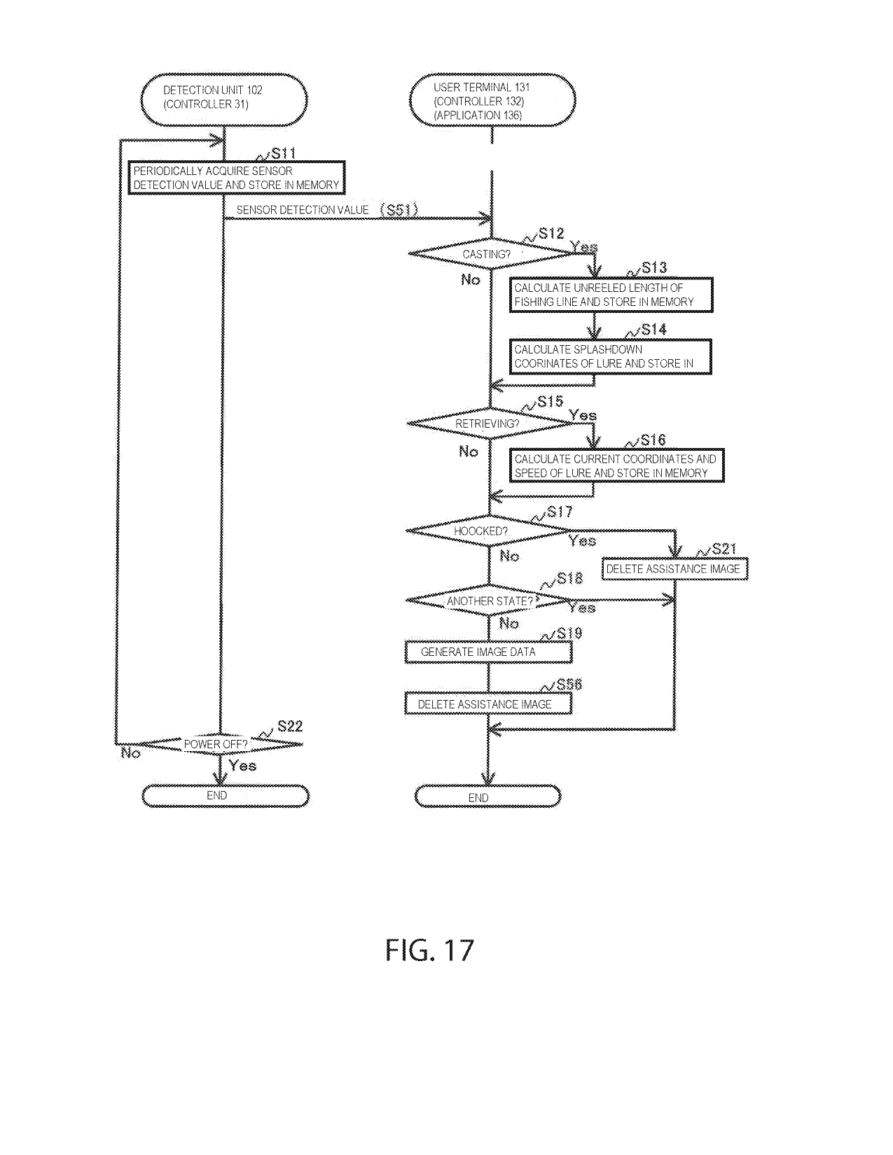

FIG. 17 shows a flowchart of a process executed by the controller 31 of the detection unit 102 and the controller 132 of the user terminal 131.

The process executed by the controller 31 is a process executed by the detection unit 102, and is also a process that the control program 34 causes the CPU 32 to execute. The process executed by the controller 132 is a process executed by the user terminal 131, and is also a process that the app 136 causes the CPU 133 to execute.

The controller 31 of the fishing reel 101 periodically acquires sensor detection values output by the sensor group 40 (S11). The controller 31 transmits the acquired sensor detection values to the user terminal 131 via the wireless communication module 103 (S51).

The controller 132 of the user terminal 131 transmits the sensor detection values via the wireless communication module 138 (S51). The controller 132 executes the process from step S12 to S19 on the basis of the sensor detection values that have been received. The process of steps S14 and S16 executed by the controller 132 (app 136) is one example of the "location information calculation process" described in the present disclosure.

When it is determined that a fish has been hooked in step S17 (S17: Yes), the controller 132 turns off the assistance image displayed on the touch panel 137. In addition, when it is determined to be "another state" in which the angler is carrying out neither casting nor retrieval in step S18 (S18: Yes), the controller 132 skips the processes of steps S19 and S56, and maintains the assistance image currently displayed on the touch panel 137.

The controller 132 causes the touch panel to display the assistance image (refer to FIG. 5) indicated by the image data generated in step S19.

The controller 31 of the detection unit 102 of the fishing reel 101 periodically and repeatedly executes the process from step S11 onward until the angler turns the power off (S22: No).

### 4. Lure fishing by an angler

Prior to actual fishing, the angler activates the app 136 on the user terminal 131 carried by the user. The activated app 136 communicates with the fishing reel 101.

An angler operates the clutch operation lever 24 to the disengagement position, and then swings the fishing rod 12 to carry out casting. The cast causes the lure 14 to splash down at a position away from the angler. When the lure 14 splashes down, an assistance image including the angler object 51, the splashdown position object 52, the lure object 53, the orientation object 54, and the like, is displayed on the touch panel 137 of the user terminal 131. The angler operates the handle 25 and carries out retrieval while checking the location of the lure 14 in the assistance image.

### 5. Action and effects of the sixth embodiment

The controller 31 calculates, and outputs over time, position coordinates indicating the location of the lure 14 on the basis of the detection values output by the sensor group 40. The position coordinates that are output over time indicate the behavior of the lure 14. That is, the fishing tackle 10 outputs, in real time, the behavior of the lure 14 in water. As a result, the fishing assistance system 150 can improve the angler's catch results.

The acceleration sensor 41 outputs detection values corresponding to the raising and lowering of the fishing rod 12 by the angler during retrieval. The rotation sensor 42 detects a detection value corresponding to the rotation operation of the handle 25 by the angler. The controller 31 calculates the displacement of the lure 14 due to the raising and lowering of the fishing rod 12 on the basis of the detection values of the acceleration sensor 41, and calculates the displacement of the lure 14 due to the rotation operation of the handle 25 on the basis of the detection value of the rotation sensor 42. That is, by being provided with the acceleration sensor 41 and the rotation sensor 42, the fishing tackle 10 is able to accurately calculate the position coordinates of the lure 14 during retrieval.

By providing the positional sensor 43 on the fishing reel 101, the controller 31 is able to calculate the position coordinates of the lure 14 as coordinates in a coordinate system that uses the angler holding the fishing tackle 10 as a reference point and a cardinal direction (north, south, east, west) as the reference axis.

Since the wireless communication module 103 is provided on the fishing reel 101, it is possible to allow the angler to check the assistance image without providing a display in the fishing tackle 100.

The assistance image is displayed on the touch panel 137 of the user terminal 131. Accordingly, it is not necessary to provide a display on the fishing reel 101 or the fishing rod 12.

The controller 132 provided on the fishing reel 101 executes only a process of periodically transmitting sensor detection values to the user terminal 131 (S51). Accordingly, the configuration of the detection unit 102 can be simplified.

### Modified Example of the sixth embodiment

In the sixth embodiment, an example was described in which the app 136 is not included in the fishing tackle 100. However, the app 136 can be included in the fishing tackle 100. That is, the app 136 can be provided to the angler with the purchase of the fishing tackle 100.

### Modified examples of the first to the sixth embodiments

In the first to the sixth embodiments, examples were described in which the speed of the lure 14 is also displayed on the display 35 in addition to the location information of the lure 14. However, the display 35 can display only the location information of the lure 14 without displaying the speed of the lure 14.

The detection units 30, 70, 83, and 102 can comprise a GPS (GNSS) transceiver antenna instead of the positional sensor 43. The GPS (GNSS) transceiver antenna receives GPS (GNSS) location information. The GPS (GNSS) location information is latitude and longitude information. In that case, the splashdown coordinates of the lure 14 are indicated by latitude and longitude. Angler coordinates, which indicate the current location of the angler, are also stored in the memory 33 in association with the splashdown coordinates of the lure 14. In the case that the detection units 30, 70, 83, and 102 include a GPS (GNSS) transceiver antenna, even if the angler fishes on a boat and the location of the angler changes constantly, the controller 31 can easily calculate the current coordinates of the lure 14 and the speed of the lure 14 from the latitude and longitude information.

In the first to the sixth embodiments, examples were described in which the sensor group 40 includes the acceleration sensor 41 that detects acceleration in directions along three mutually orthogonal axes. However, the sensor group 40 can be provided with a six-axis acceleration sensor instead of the acceleration sensor 41. The six-axis acceleration sensor detects the three accelerations in directions along three mutually orthogonal axes, and three angular accelerations, which are accelerations in the circular directions on three mutually orthogonal planes. The six-axis acceleration sensor is a so-called gyro sensor.

In the first to the sixth embodiments, examples were described in which the acceleration sensor 41 is attached to the fishing reel 11. However, three acceleration sensors can be attached to the fishing reel 11 instead of the acceleration sensor 41.

In the first to the sixth embodiments, examples were described in which the location information of the lure 14 calculated by the controller 31 on the basis of the sensor detection values is position coordinates that uses the angler as the reference point (origin). However, the location information of the lure 14 calculated by the controller 31 on the basis of the sensor detection values can be position coordinates that use the splashdown position as a reference point (origin). In the case of position coordinates that use the splashdown position as a reference point (origin), in step S16, the controller 31 calculates the travel distance of the lure 14 from the splashdown position on the basis of the detection values of the acceleration sensor 41 and the rotation sensor 42, and calculates, and stores in the memory 33, the position coordinates that use the splashdown position as a reference point (origin) on the basis of the calculated distance and the orientation detected by the positional sensor 43. The travel distance of the lure 14 from the splashdown position is displayed in the assistance image (refer to FIG. 4) instead of a numerical value indicating the distance from the angler to the lure 14.

In the first to the sixth embodiments, examples were described in which the rotation sensor 42, the lever detection sensor 44, and the bail detection sensor 73 are sensors that use magnetic sensors. However, the rotation sensor 42, the lever detection sensor 44, and the bail detection sensor 73 can be sensors that use optical sensors such as photointerrupters. In that case, instead of magnets, mirrors are attached to the spool 22, the clutch operation lever 24, the bail 66. On the other hand, light-emitting diodes that emit laser light and photodiodes that receive reflected light reflected by mirrors are attached to the reel bodies 21 and 63 instead of magnetic sensors.

In addition to the sensors described in the first to the sixth embodiments, such as the acceleration sensor 41, other sensor maybe be provided on the fishing reels 11, 61, 101 or the fishing rod 81. An example of another sensor is a stereo camera that images the fishing rods 12, 81, etc. The stereo camera is provided on the fishing reels 11, 61, 101, for example, and the imaging area thereof includes the rod tip of the fishing rods 12, 81. The image data generated by the stereo camera by imaging are input to the controllers 31, 121. The controllers 31, 121 further calculate the casting distance of the lure 14, the wound amount of the fishing line 13, and the speed of the lure 14 on the basis of the amount of change (flexure amount) of the rod tip of the fishing rods 12, 81 indicated by the captured image data, and the lure 14 appearing in the captured image. Alternatively, the controllers 31, 121 acquire the elevation angles of the fishing rods 12, 81 on the basis of the positional sensor 43, acquire the intersection angle between the fishing rods 12, 81 and the fishing line 13 at the rod tip on the basis of the captured image data, and calculate the water depth of the lure 14 on the basis of the elevation angle, the intersection angle, and the unreeled length of the fishing line 13. The controllers 31, 121 display, in the assistance image, a numerical value indicating the water depth of the lure 14.

What is claimed is:

1. A fishing tackle including a fishing rod or a fishing reel, the fishing tackle comprising:
a detection unit provided on the fishing tackle and configured to output a detection value corresponding to an operation of the fishing tackle; and
a calculation unit configured to calculate and output location information indicating a location of a fishing rig attached to a fishing line of the fishing tackle on a basis of the detection value.

2. The fishing tackle according to claim 1, further comprising
the fishing reel having a spool around which a fishing line is configured to be wound, and a handle, and
the detection unit includes
a rotation sensor configured to detect a detection value corresponding to a rotation of the handle, and
an acceleration sensor with three or more axes.

3. The fishing tackle according to claim 1, wherein
the detection unit includes a positional sensor configured to output s positional information indicating a position, and
the location information is coordinate information in a coordinate system having the fishing tackle as an origin and reference axes corresponding to cardinal directions.

4. The fishing tackle according to claim 1, further comprising
a display unit configured to receive input of the location information and to display the location of the fishing rig indicated by the location information.

5. The fishing tackle according to claim 1, further comprising
a communication unit configured to transmit the detection value or the location information.

6. The fishing tackle according to claim 1, further comprising
a display unit configured to receive input of the location information and fish finder image data representing a fish finder image, and to display a specific object indicating the fishing rig superimposed on the fish finder image.

7. The fishing tackle according to claim 1, further comprising
a communication unit configured to communicate with a user terminal and to transmit the detection value,
the calculation unit includes an application program installed on the user terminal and is executed by a computer of the user terminal, and
the application program is configured to execute a display process to input and display, on a display unit of the user terminal, the location of the fishing rig indicated by the location information.

8. A fishing assistance system comprising:
a fishing tackle including a fishing rod or a fishing reel, a detection unit configured to output a detection value corresponding to an operation of the fishing rod or of the fishing reel, and a first communication unit configured to transmit the detection value;
an application program installed on a user terminal that includes a display unit, a second communication unit, and a computer; and
a management server having a third communication unit and a server controller,
the application program causes the computer to execute
a process to receive the detection value transmitted by the first communication unit via the second communication unit, and
a process to transmit data request including the received detection value to the management server via the second communication unit and the Internet,
the server controller executes
a process to receive the detection value via the third communication unit,
a location information calculation process to calculate location information indicating a location of a fishing rig attached to the fishing tackle on a basis of the received detection value, and
an image data response process to reply, to the user terminal via the third communication unit and the Internet, a data response including image data representing an assistance image obtained by disposing a specific object representing the fishing rig at the location indicated by the location information, as a response to the data request, and
the application program causes the computer to execute
a process to receive the data response including the image data via the third communication unit, and
a display process configured to display, on the display unit, the assistance image indicated by the received image data.

9. A fishing assistance system comprising:
a fishing tackle including a fishing rod or a fishing reel, a detection unit configured to output a detection value corresponding to an operation of the fishing rod or of the fishing reel, and a communication unit configured to transmit the detected value; and
an application program installed on a user terminal that includes a display unit, a reception unit, and a computer;
the application program causes the computer to execute
a process to receive the detection value transmitted by the communication unit via the reception unit,
a location information calculation process to calculate location information indicating a location of a fishing rig attached to the fishing tackle on a basis of the received detection value, and
a display process configured to display, on the display unit, an assistance image obtained by disposing a specific object representing the fishing rig at a location indicated by the location information.
